(19) United States
(12) Patent Application Publication
(10) Pub. No.: US 2026/0202583 A1
(43) Pub. Date: Jul. 16, 2026

(54) LIGHT ABSORPTION ANISOTROPIC FILM, OPTICAL FILM, AND IMAGE DISPLAY APPARATUS

(71) Applicant: FUJIFILM Corporation, Tokyo (JP)

(72) Inventor: Naoya NISHIMURA, Minamiashigara-shi (JP)

(73) Assignee: FUJIFILM Corporation, Tokyo (JP)

(21) Appl. No.: 19/562,846

(22) Filed: Mar. 11, 2026

Related U.S. Application Data
(63) Continuation of application No. PCT/JP2024/034741, filed on Sep. 27, 2024.

(30) Foreign Application Priority Data
Sep. 29, 2023 (JP) 2023-170603

(51) Int. Cl. G02B 1/08; G02B 5/00

(52) U.S. Cl. CPC G02B 1/08; G02B 5/003

(57) ABSTRACT

A first object of the present invention is to provide a light absorption anisotropic film having excellent light resistance and excellent alignment property of a dichroic substance. A second object of the present invention is to provide an optical film and an image display apparatus.

The light absorption anisotropic film according to the present invention is a light absorption anisotropic film including: a liquid crystal compound; a dichroic substance; and a phenol compound, in which an angle θ between a transmittance central axis of the light absorption anisotropic film and a normal direction of a surface of the light absorption anisotropic film is 0° to 45°, and the phenol compound includes a compound represented by Formula (1).

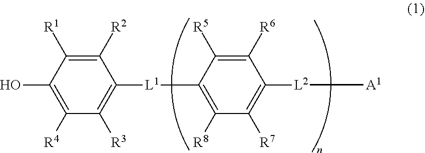

### CROSS-REFERENCE TO RELATED APPLICATIONS

This application is a Continuation of PCT International Application No. PCT/JP2024/034741 filed on Sep. 27, 2024, which claims priority under 35 U.S.C. § 119(a) to Japanese Patent Application No. 2023-170603 filed on Sep. 29, 2023. The above applications are hereby expressly incorporated by reference, in their entirety, into the present application.

### BACKGROUND OF THE INVENTION

### 1. Field of the Invention

The present invention relates to a light absorption anisotropic film, an optical film, and an image display apparatus.

### 2. Description of the Related Art

In order to prevent peeping into an image display apparatus and control the viewing angle, a technique of using a light absorption anisotropic film having an absorption axis in the thickness direction is known. For example, JP2022-136111A discloses a cured film of a liquid crystal composition containing a polymerizable liquid crystal compound, a non-liquid crystal compound containing a reactive group, and a dichroic coloring agent, in which the polymerizable liquid crystal compound and the dichroic coloring agent are cured in a state of being aligned in a direction perpendicular to a plane of the light absorption anisotropic film.

### SUMMARY OF THE INVENTION

In the light absorption anisotropic film, further improvement in light resistance and alignment property of a dichroic substance is required.

As a result of studying the light absorption anisotropic film specifically disclosed in JP2022-136111A, the present inventors have clarified that the light resistance and the alignment property of the dichroic substance may not be compatible. That is, it has been found that there is room for study on a light absorption anisotropic film in which both the light resistance and the alignment property of the dichroic substance are excellent.

Therefore, an object of the present invention is to provide a light absorption anisotropic film having excellent light resistance and excellent alignment property of a dichroic substance.

Another object of the present invention is to provide an optical film and an image display apparatus.

The present inventors found that the above-described problems can be solved by employing the following configurations.

[1] Alight absorption anisotropic film comprising:
a liquid crystal compound;
a dichroic substance; and
a phenol compound,
in which an angle θ between a transmittance central axis of the light absorption anisotropic film and a normal direction of a surface of the light absorption anisotropic film is 0° to 45°, and
the phenol compound includes a compound represented by Formula (1).

[2] The light absorption anisotropic film according to [1], further comprising:
one or more compounds selected from the group consisting of a silane coupling agent, a hydrolyzate of the silane coupling agent, and a hydrolytic condensate of the silane coupling agent.

[3] The light absorption anisotropic film according to [1] or [2], further comprising:
an ionic compound.

[4] An optical film comprising:
a substrate; and
the light absorption anisotropic film according to any one of [1] to [3], disposed on the substrate.

[5] The optical film according to [4], further comprising:
a protective layer on a surface of the light absorption anisotropic film opposite to a substrate side.

[6] The optical film according to [5],
in which the protective layer includes polyvinyl alcohol or a derivative of the polyvinyl alcohol.

[7] An image display apparatus comprising:
the optical film according to any one of [4] to [6].

According to the present invention, a light absorption anisotropic film having excellent light resistance and excellent alignment property of a dichroic substance can be provided.

In addition, according to the present invention, an optical film and an image display apparatus can be provided.

### DESCRIPTION OF THE PREFERRED EMBODIMENTS

Hereinafter, the present invention will be described in detail.

The description of configuration requirements below may be made based on typical embodiments or specific examples, but the present invention is not limited to such embodiments.

In the present specification, a numerical range represented by using “to” means a range including numerical values described before and after “to” as a lower limit value and an upper limit value.

In the present specification, a term “absorption axis” denotes a polarization direction in which absorbance is maximized in a plane in a case where linearly polarized light is incident. In addition, a term “reflection axis” denotes a polarization direction in which a reflectivity is maximized in a plane in a case where linearly polarized light is incident. In addition, a term “transmission axis” denotes a direction orthogonal to the absorption axis or the reflection axis in a plane. Furthermore, a term “slow axis” denotes a direction in which a refractive index is maximized in a plane.

In addition, in the present specification, Re(λ) and Rth(λ) represent an in-plane retardation and a thickness direction retardation at a wavelength λ, respectively. Unless otherwise specified, it is assumed that the wavelength λ is 550 nm.

In the present invention, Re(λ) and Rth(λ) are values measured at the wavelength λ in AxoScan (manufactured by Axometrics, Inc.). By inputting an average refractive index ((nx+ny+nz)/3) and a film thickness (d (μm)) in AxoScan,
a slow axis direction (°),

$$Re ( λ ) = R 0 ( λ ) , and$$

$$Rth ( λ ) = ( ( n x + ny ) / 2 - nz ) \times d$$

are calculated.

Although R0(λ) is displayed as a numerical value calculated by AxoScan, it means Re(λ).

In addition, in the present specification, the refractive indices nx, ny, and nz are measured using an Abbe refractometer (NAR-4T, manufactured by Atago Co., Ltd.), and a sodium lamp (λ=589 nm) is used as a light source. In addition, the wavelength dependence can be measured using a combination of a multi-wavelength Abbe refractometer DR-M2 (manufactured by Atago Co., Ltd.) and an interference filter.

In addition, values in Polymer Handbook (John Wiley & Sons, Inc.) and catalogs of various optical films can be used. Values of the average refractive index of main optical films are exemplified as follows: cellulose acylate (1.48), cycloolefin polymer (1.52), polycarbonate (1.59), polymethylmethacrylate (1.49), and polystyrene (1.59).

In the present specification, an A-plate and a C-plate are defined as follows.

There are two types of A-plates, a positive A-plate (A-plate which is positive) and a negative A-plate (A-plate which is negative). The positive A-plate satisfies a relationship of Expression (A1) and the negative A-plate satisfies a relationship of Expression (A2) in a case where a refractive index in a film in-plane slow axis direction (in a direction in which an in-plane refractive index is maximum) is denoted by nx, a refractive index in an in-plane direction orthogonal to the in-plane slow axis is denoted by ny, and a refractive index in a thickness direction is denoted by nz. The positive A-plate has an Rth showing a positive value and the negative A-plate has an Rth showing a negative value.

$$n x > ny \approx nz \qquad Expression ( A1 )$$

$$ny < nx \approx nz \qquad Expression ( A2 )$$

The symbol “~” encompasses not only a case where both sides are completely the same as each other but also a case where both sides are substantially the same as each other. The expression “substantially the same” means that, for example, a case where (ny−nz)×d (in which d is a thickness of a film) is −10 to 10 nm and preferably −5 to 5 nm is also included in “ny≈nz”; and a case where (nx−nz)×d is −10 to 10 nm and preferably −5 to 5 nm is also included in “nx≈nz”.

There are two types of C-plates, a positive C-plate (C-plate which is positive) and a negative C-plate (C-plate which is negative). The positive C-plate satisfies a relationship of Expression (C1) and the negative C-plate satisfies a relationship of Expression (C2). The positive C-plate has an Rth showing a negative value and the negative C-plate has an Rth showing a positive value.

$$nz > nx \approx ny \qquad Expression ( C1 )$$

$$nz < nx \approx ny \qquad Expression ( C2 )$$

The symbol “≈” encompasses not only a case where both sides are completely the same as each other but also a case where both sides are substantially the same as each other. The phrase “substantially the same as each other” means that, for example, a case where (nx−ny)×d (where d is a thickness of a film) is 0 to 10 nm and preferably 0 to 5 nm is also included in “nx≈ny”.

In the present specification, for each component, one kind of substance corresponding to each component may be used alone, or two or more kinds thereof may be used in combination. Here, in a case where two or more kinds of materials are used in combination for each component, the content of the component refers to the total content of the materials to be combined unless specified otherwise.

In the present specification, “(meth)acryloyl” is used to mean “either or both of acryloyl and methacryloyl”.

In the present specification, the solid content of the composition means a component forming a composition layer, and does not include a solvent. The component forming the composition layer may be a component that reacts (polymerizes) to change a chemical structure in a case of forming the composition layer. In addition, the component forming the composition layer is regarded as a solid content even in a case of being in a liquid state.

A bonding direction of divalent groups cited in the present specification is not limited unless otherwise specified. For example, in a case where Y in a compound represented by Formula “X—Y—Z” is —COO—, Y may be —CO—O— or —O—CO—. In addition, the above-described compound may be “X—CO—O—Z” or “X—O—CO—Z”.

### [Light Absorption Anisotropic Film]

The light absorption anisotropic film according to the embodiment of the present invention is a light absorption anisotropic film containing a liquid crystal compound, a dichroic substance, and a phenol compound,
an angle θ between a transmittance central axis of the light absorption anisotropic film and a normal direction of a surface of the light absorption anisotropic film is 0° to 45°, and
the phenol compound includes a compound represented by Formula (1) (hereinafter, also referred to as “specific phenol compound”).

The light absorption anisotropic film having the above-described configuration has excellent light resistance and excellent alignment property of the dichroic substance.

The action mechanism is not always clear, but the present inventors estimate as follows.

That is, the specific phenol compound can function as an alignment agent (vertical alignment agent) that is surface-segregated in the light absorption anisotropic film due to the structure thereof and promotes vertical alignment of the liquid crystal compound. As a result, it is presumed that the dichroic substance has excellent alignment property in the light absorption anisotropic film. In addition, the specific phenol compound also functions as an antioxidant having an action of preventing auto-oxidation by capturing a radical, and it is presumed that the light absorption anisotropic film has excellent light resistance.

Hereinafter, it is also referred to that the light resistance of the light absorption anisotropic film according to the embodiment of the present invention is more excellent and/or the alignment property of the dichroic substance in the light absorption anisotropic film according to the embodiment of the present invention is more excellent as “the effect of the present invention is more excellent”.

Hereinafter, various components contained in the light absorption anisotropic film will be described in detail.

### [Liquid Crystal Compound]

As such a liquid crystal compound, both a polymer liquid crystal compound and a low-molecular-weight liquid crystal compound can be used. The high-molecular-weight liquid crystal compound and the low-molecular-weight liquid crystal compound may be used in combination as the liquid crystal compound.

Here, the “polymer liquid crystal compound” refers to a liquid crystal compound having a repeating unit in the chemical structure. In addition, the “low-molecular-weight liquid crystal compound” refers to a liquid crystal compound having no repeating unit in the chemical structure.

The liquid crystallinity exhibited by the liquid crystal compound may be thermotropic liquid crystal or lyotropic liquid crystal. In addition, the phase-ordered structure in the thermotropic liquid crystal may be a nematic liquid crystal or a smectic liquid crystal.

Examples of the liquid crystal compound include a liquid crystal compound exhibiting positive wavelength dispersibility and a liquid crystal compound exhibiting negative wavelength dispersibility, and any one thereof may be used alone or both thereof may be used in combination. Among these, a liquid crystal compound exhibiting positive wavelength dispersibility is desirable.

In the light absorption anisotropic film, the liquid crystal compound is preferably fixed in an aligned state, and more preferably fixed in an aligned state by polymerization. In a case where the liquid crystal compound is fixed in an aligned state by polymerization in the light absorption anisotropic film, the light absorption anisotropic film typically contains a cured substance cured in a state where a polymerizable liquid crystal compound is aligned.

The polymerizable liquid crystal compound is a liquid crystal compound having a polymerizable group (preferably a photopolymerizable group). The polymerizable liquid crystal compound is not particularly limited, and for example, a polymerizable liquid crystal compound known in the related art in the field of a phase difference film can be appropriately used.

Examples of the polymerizable group include a vinyl group, a vinyloxy group, a 1-chlorovinyl group, an isopropenyl group, a 4-vinylphenyl group, a (meth)acryloyloxy group, an oxiranyl group, and an oxetanyl group, and among these, a (meth)acryloyloxy group is preferable.

Hereinafter, specific examples of the polymerizable liquid crystal compound will be described.

Examples of the polymerizable liquid crystal compound include a compound containing a group represented by Formula (Y) (hereinafter, also referred to as “polymerizable liquid crystal compound (Y)”). The polymerizable liquid crystal compound (Y) generally tends to exhibit positive wavelength dispersibility.

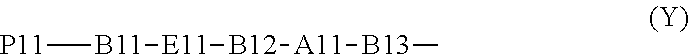

In Formula (Y), P11 represents a polymerizable group. A11 represents a divalent alicyclic hydrocarbon group or a divalent aromatic hydrocarbon group. The hydrogen atom contained in the divalent alicyclic hydrocarbon group and the divalent aromatic hydrocarbon group may be substituted with a halogen atom, an alkyl group having 1 to 6 carbon atoms, an alkoxy group having 1 to 6 carbon atoms, a cyano group, or a nitro group, and the hydrogen atom contained in the alkyl group having 1 to 6 carbon atoms and the alkoxy group having 1 to 6 carbon atoms may be substituted with a fluorine atom. B11 represents —O—, —S—, —CO—O—, —O—CO—O—, —CO—NR¹⁶—, —CO—, —CS—, or a single bond. B12 and B13 each independently represent —C≡C—, —CH═CH—, —CH₂—CH₂—, —O—, —S—, —CO—, —CO—O—, —O—CO—O—, —CH═N—, —N═N—, —CO—NR¹⁶—, —OCH₂—, —OCF₂—, —CH═CH—CO—O—, or a single bond. R¹⁶ represents a hydrogen atom or an alkyl group having 1 to 6 carbon atoms. E11 represents an alkanediyl group having 1 to 12 carbon atoms, and the hydrogen atom contained in the alkanediyl group may be substituted with an alkoxy group having 1 to 5 carbon atoms, and the hydrogen atom contained in the alkoxy group may be substituted with a halogen atom. In addition, at least one —CH₂— constituting the alkanediyl group may be substituted with —O— or —CO—.

The number of carbon atoms in the aromatic hydrocarbon group and the alicyclic hydrocarbon group of A11 is preferably 3 to 18, more preferably 5 to 12, and still more preferably 5 or 6. As A11, a cyclohexane-1,4-diyl group or a 1,4-phenylene group is preferable.

As E11, a linear alkanediyl group having 1 to 12 carbon atoms is preferable. At least one —CH₂— constituting the alkanediyl group may be substituted with —O—.

Specific examples of the linear alkane diyl group having 1 to 12 carbon atoms represented by E11 include linear alkane diyl groups having 1 to 12 carbon atoms such as a methylene group, an ethylene group, a propane-1,3-diyl group, a butane-1,4-diyl group, a pentane-1,5-diyl group, a hexane-1,6-diyl group, a heptane-1,7-diyl group, an octane-1,8-diyl group, a nonane-1,9-diyl group, a decane-1,10-diyl group, an undecane-1,11-diyl group, and a dodecane-1,12-diyl group; —CH₂—CH₂—O—CH₂—CH₂—; —CH₂—CH₂—O—CH₂—CH₂—O—CH₂—CH₂—; and —CH₂—CH₂—O—CH₂—CH₂—O—CH₂—CH₂—O—CH₂—CH₂—.

As B11, —O—, —S—, or —CO—O— is preferable, and —CO—O— is more preferable.

B12 and B13 each independently preferably —O—, —S—, —CO—, —CO—O—, or —O—CO—O—, and more preferably —O— or —O—CO—O—.

The polymerizable group represented by P11 is not particularly limited, and examples thereof include the above-described polymerizable groups, and among these, a vinyl group, a p-styryl group, an epoxy group, or an oxetanyl group is more preferable.

As the group represented by P11-B11-, a (meth)acryloyloxy group is preferable.

Examples of the polymerizable liquid crystal compound (Y) include compounds represented by Formula (I), Formula (II), Formula (III), Formula (IV), Formula (V), or Formula (VI).

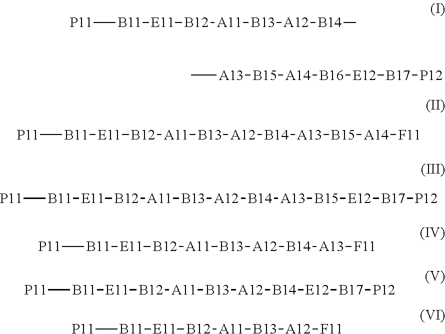

In Formulae (I) to (VI), A12 to A14 each independently have the same meaning as A11, B14 to B16 each independently have the same meaning as B12, B17 has the same meaning as B11, E12 has the same meaning as E1, and P12 has the same meaning as P11.

F11 represents a hydrogen atom, an alkyl group having 1 to 13 carbon atoms, an alkoxy group having 1 to 13 carbon atoms, a cyano group, a nitro group, a trifluoromethyl group, a dimethylamino group, a hydroxy group, a methylol group, a formyl group, a sulfo group (—SO₃H), a carboxy group, an alkoxycarbonyl group having 1 to 10 carbon atoms, or a halogen atom, and —CH₂— constituting the alkyl group and the alkoxy group may be substituted with —O—.

Specific examples of the polymerizable liquid crystal compound (Y) include compounds having a polymerizable group, which are described in “3.8.6 Network (completely crosslinked type)” and “6.5.1 Liquid crystal material b. Polymerizable nematic liquid crystal material” in Liquid Crystal Handbook (Liquid Crystal Handbook Editorial Committee, Maruzen Co., Ltd., Oct. 30, 2000), and polymerizable liquid crystals described in JP2010-031223A, JP2010-270108A, JP2011-006360A, and JP2011-207765A.

Specific examples of the polymerizable liquid crystal compound (Y) include compounds represented by Formula (I-1) to Formula (I-4), Formula (II-1) to Formula (II-4), Formula (III-1) to Formula (III-26), Formula (IV-1) to Formula (IV-26), Formula (V-1) to Formula (V-2), and Formula (VI-1) to Formula (VI-6). In the following formulae, k1 and k2 each independently represent an integer of 2 to 12.

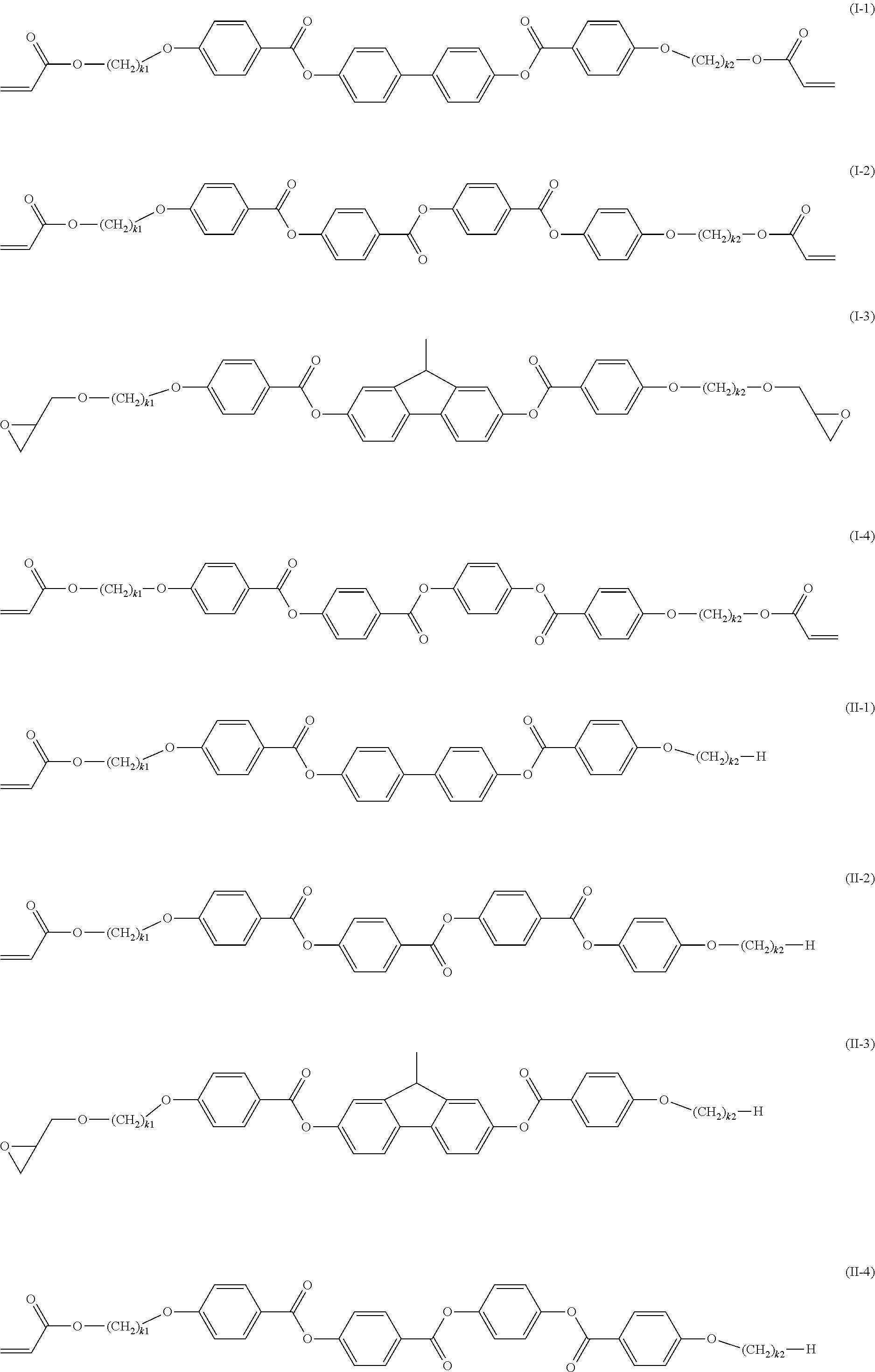

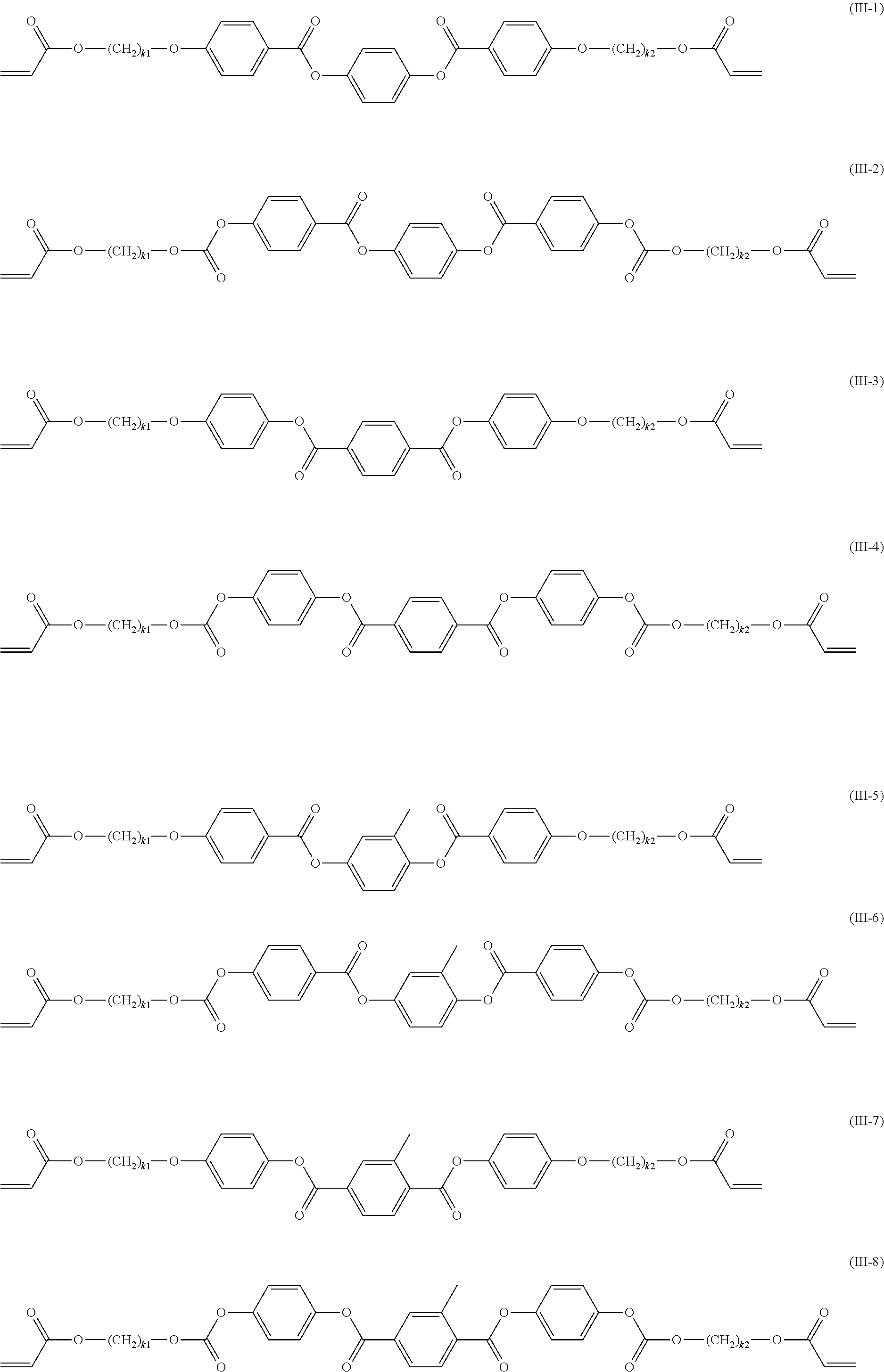

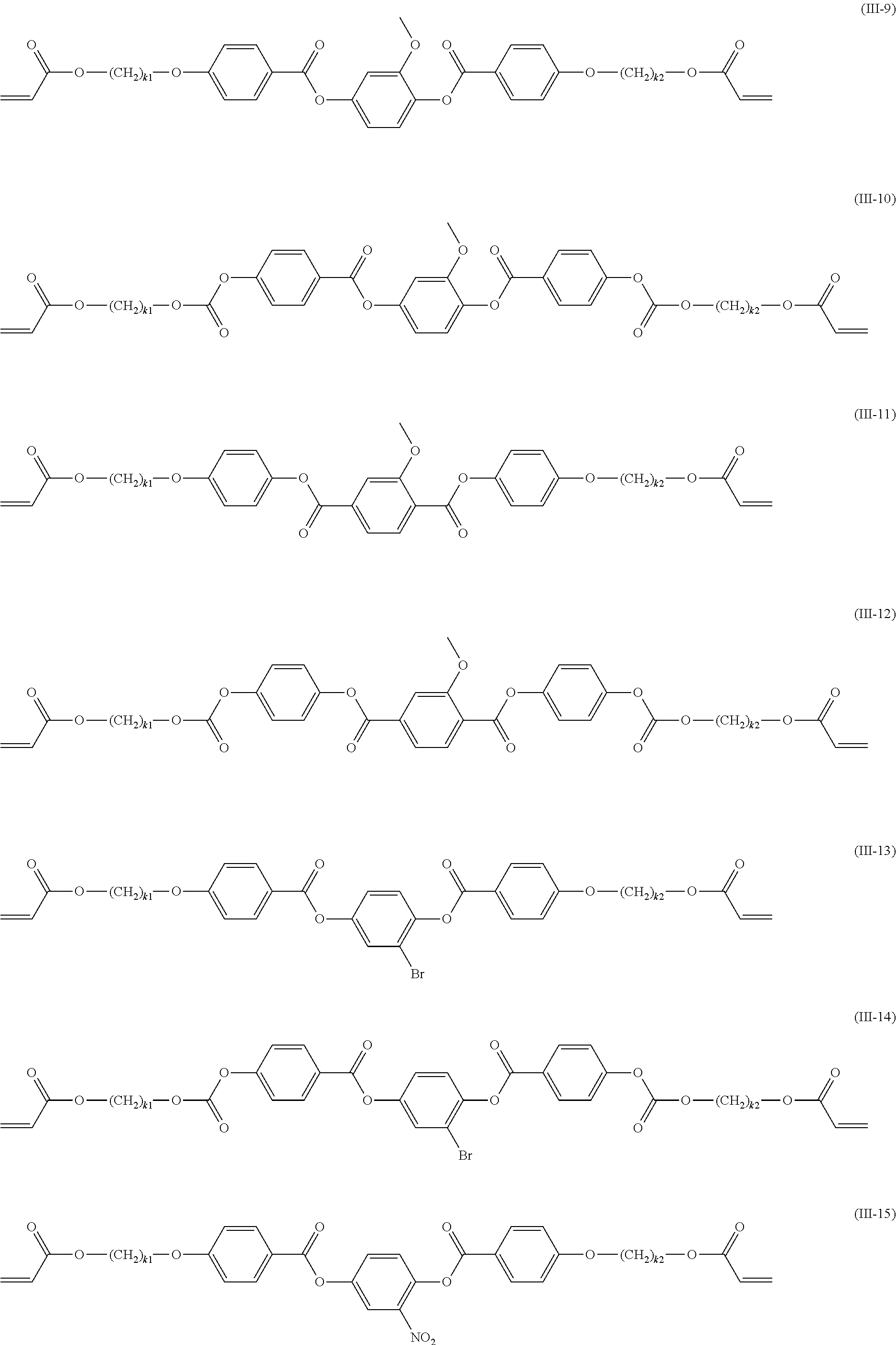

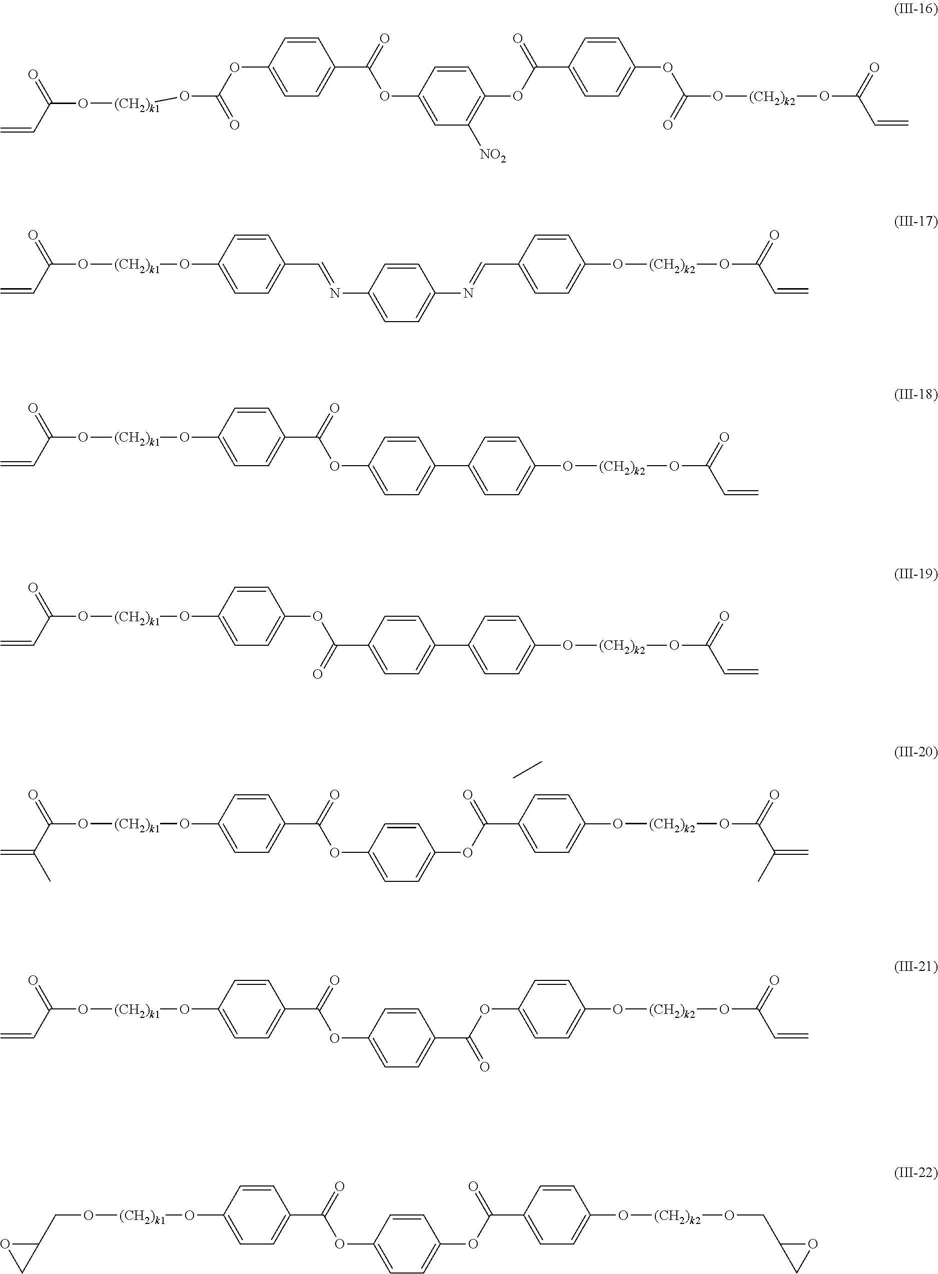

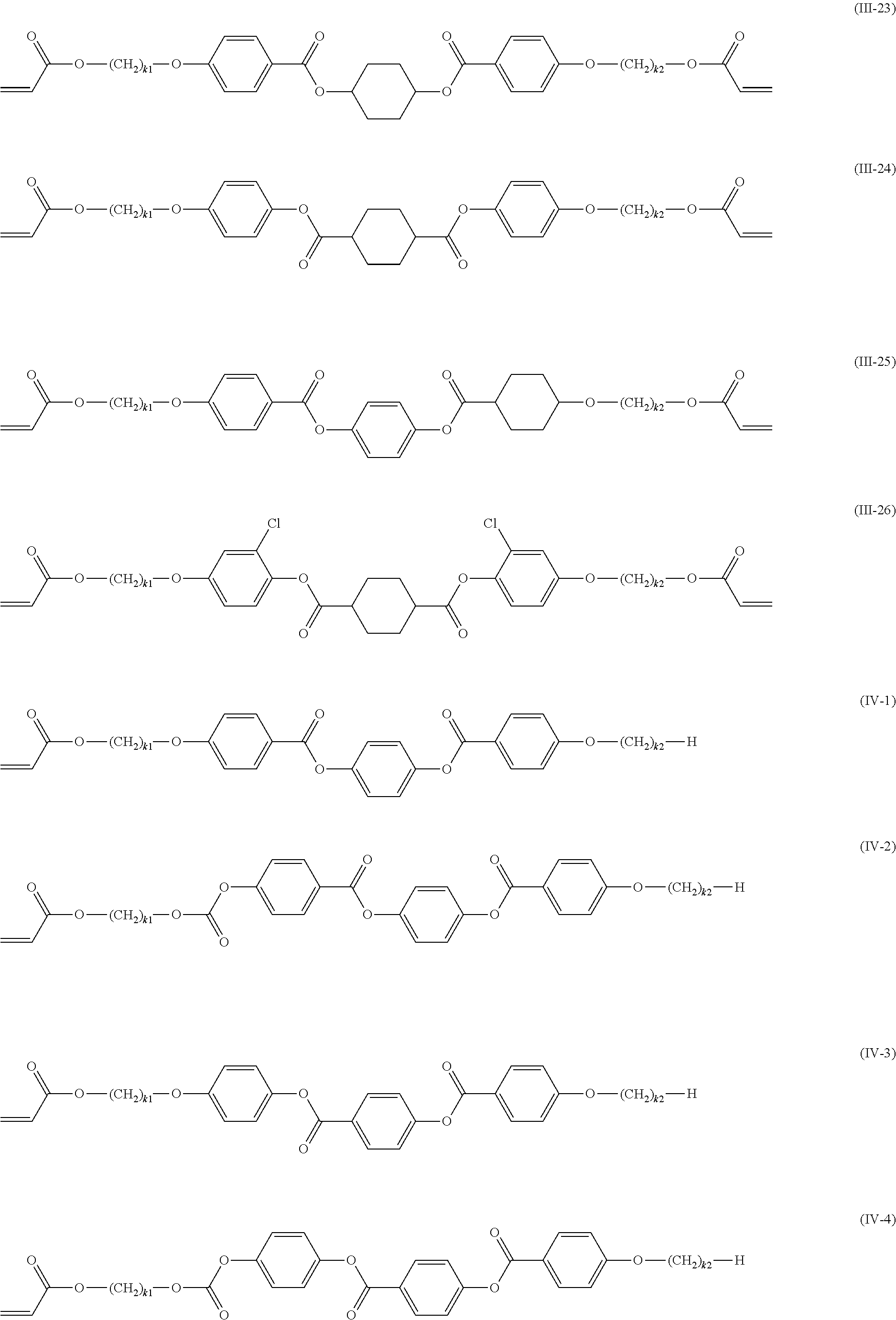

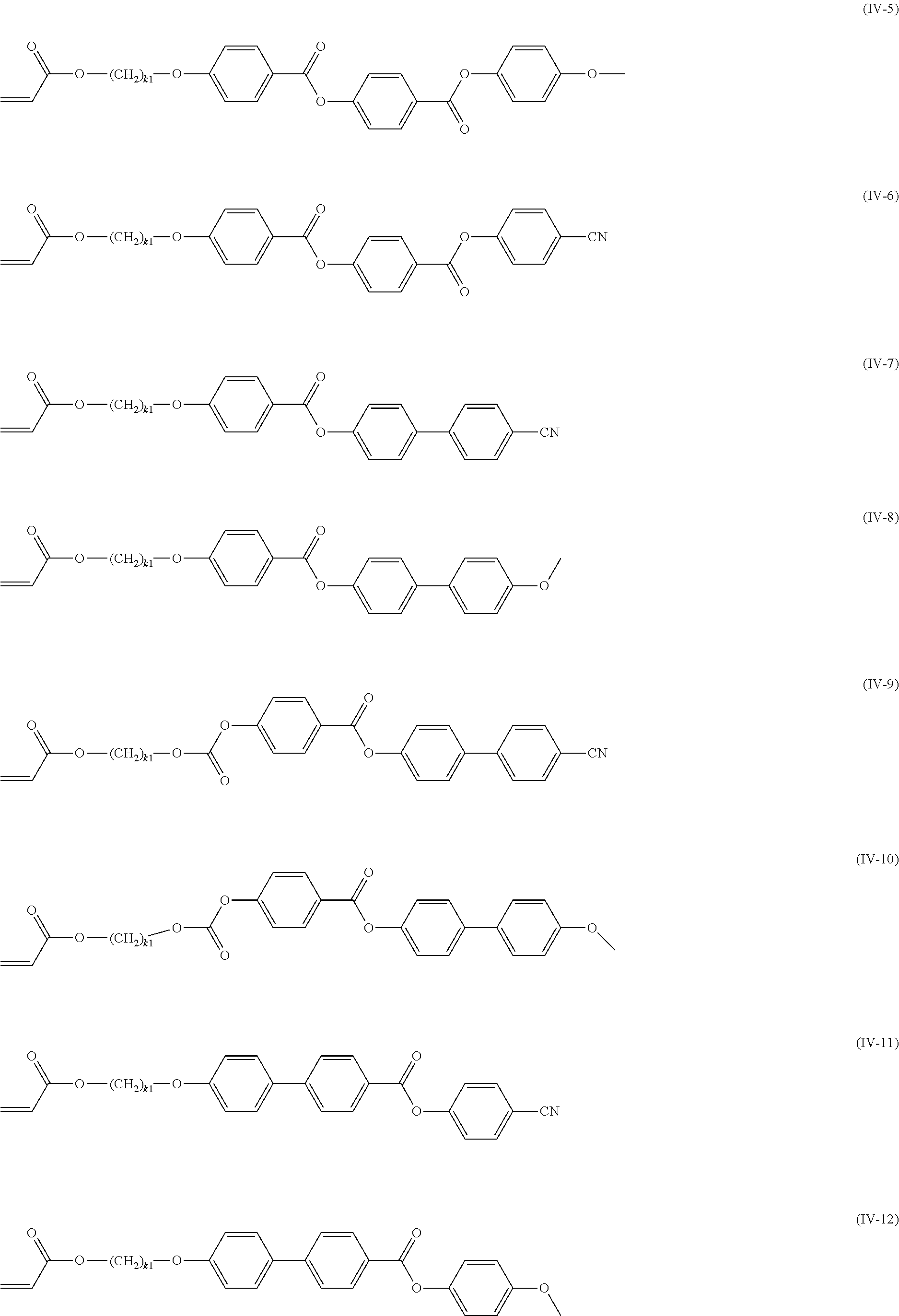

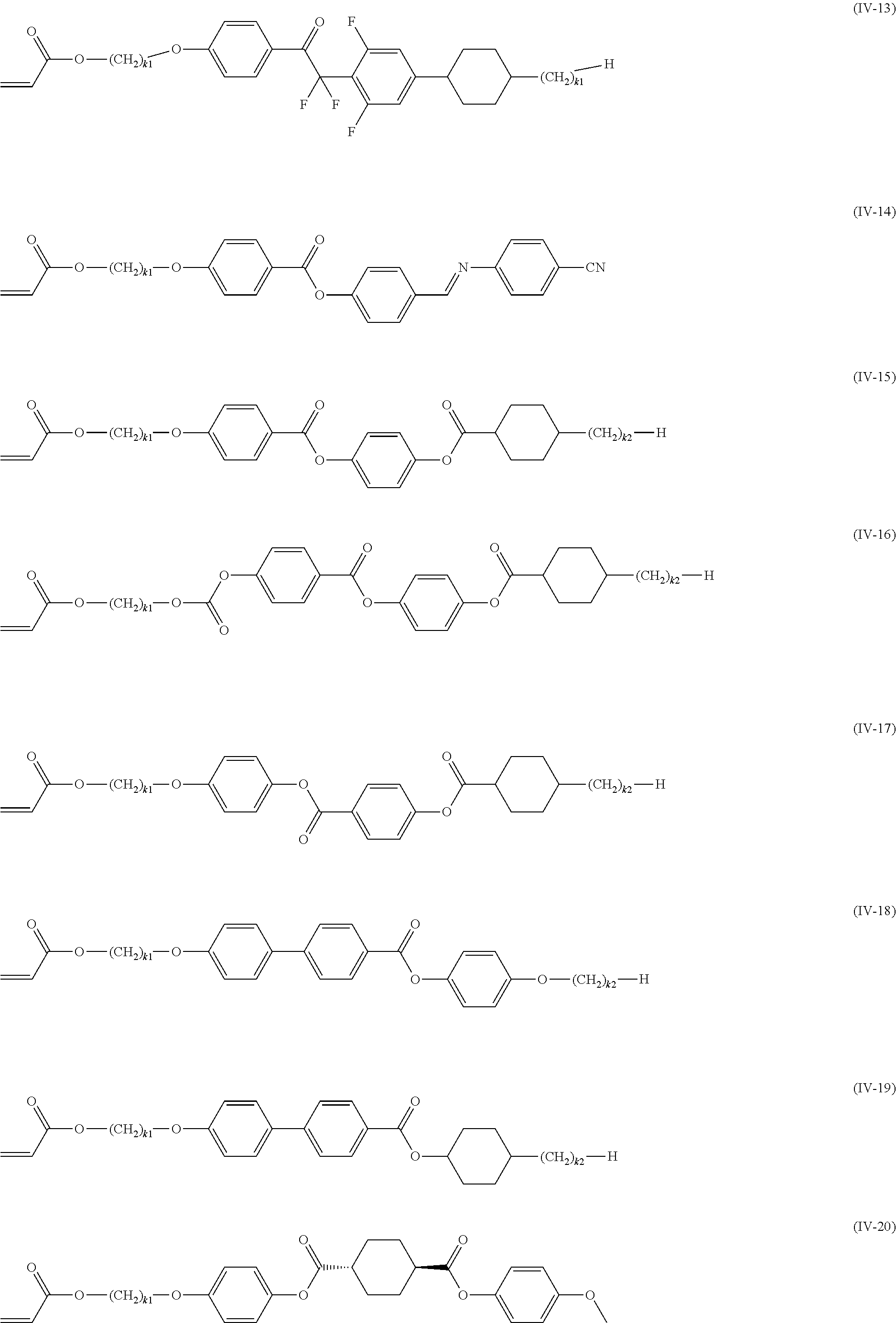

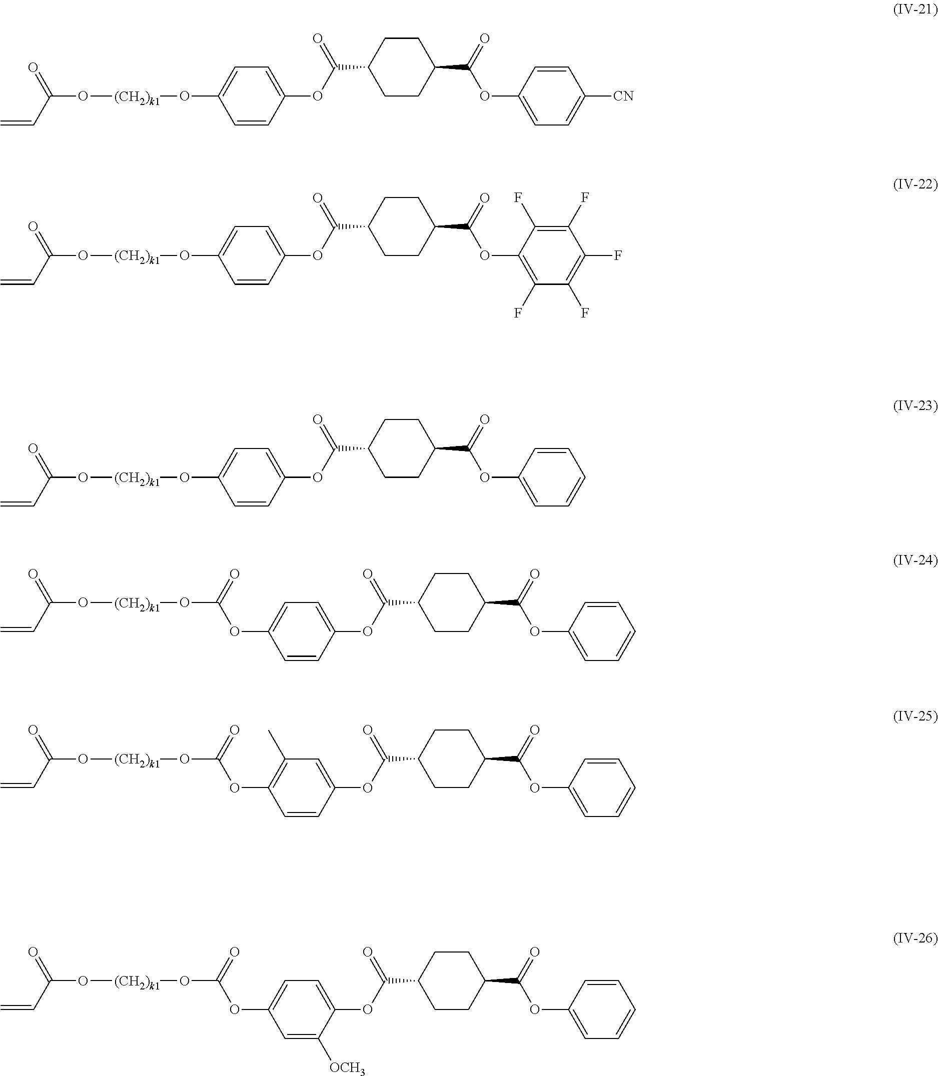

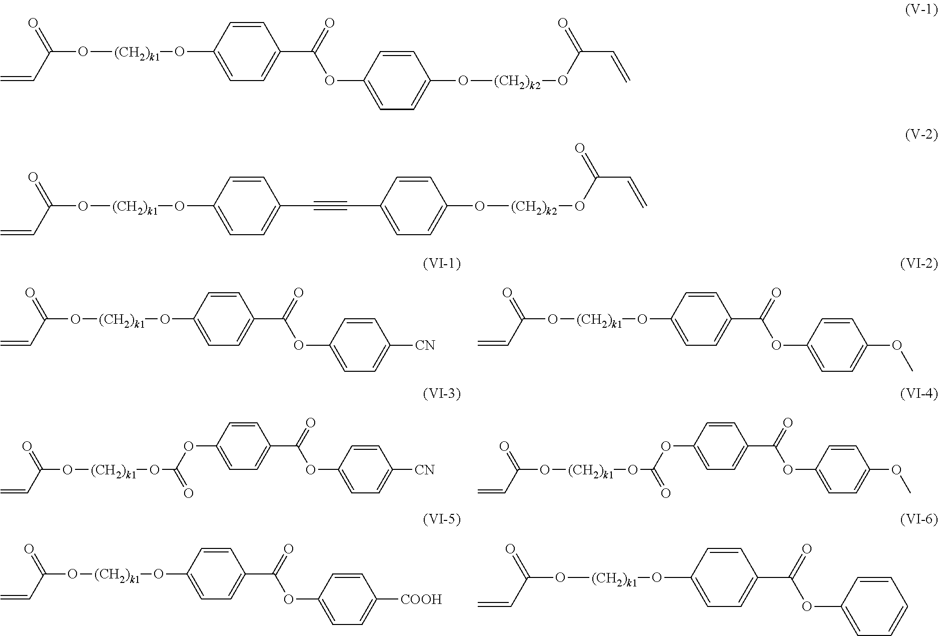

It is also preferable that the polymerizable liquid crystal compound is a polymerizable liquid crystal compound exhibiting smectic liquid crystallinity. Examples of the polymerizable liquid crystal compound exhibiting smectic liquid crystallinity include a compound represented by Formula (Z) (hereinafter, also referred to as “polymerizable liquid crystal compound (Z)”).

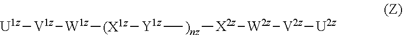

In Formula (Z), X^{1z} and X^{2z} each independently represent a divalent aromatic group or a divalent alicyclic hydrocarbon group, where the hydrogen atom contained in the divalent aromatic group or the divalent alicyclic hydrocarbon group may be substituted with a halogen atom, an alkyl group having 1 to 4 carbon atoms, a fluoroalkyl group having 1 to 4 carbon atoms, an alkoxy group having 1 to 4 carbon atoms, a cyano group, or a nitro group, and the carbon atom constituting the divalent aromatic group or the divalent alicyclic hydrocarbon group may be substituted with an oxygen atom, a sulfur atom, or a nitrogen atom. However, at least one of X^{1z} or X^{2z} is a 1,4-phenylene group which may have a substituent or a cyclohexane-1,4-diyl group which may have a substituent.

Y^{1z} is a single bond or a divalent linking group.

nz is 1 to 3, and in a case where nz is 2 or more, a plurality of X^{1z}'s may be the same as or different from each other. X^{2z} may be the same as or different from any or all of the plurality of X^{1z}'s. In addition, in a case where nz is 2 or more, a plurality of Y^{1z}'s may be the same as or different from each other. From the viewpoint of liquid crystallinity, nz is preferably 2 or more.

U^{1z} represents a hydrogen atom or a (meth)acryloyloxy group.

U^{2z} represents a polymerizable group.

W^{1z} and W^{2z} each independently represent a single bond or a divalent linking group.

V^{1z} and V^{2z} each independently represent an alkanediyl group having 1 to 20 carbon atoms, which may have a substituent, and —CH₂— constituting the alkanediyl group may be substituted with —O—, —CO—, —S—, or —NH—.

In the polymerizable liquid crystal compound (Z), X^{1z} and X^{2z} each independently represent a 1,4-phenylene group which may have a substituent or a cyclohexane-1,4-diyl group which may have a substituent, and it is preferable that at least one of X^{1z} or X^{2z} is a 1,4-phenylene group which may have a substituent or a cyclohexane-1,4-diyl group which may have a substituent, and it is more preferable that it is a trans-cyclohexane-1,4-diyl group. Examples of the optional substituent of the 1,4-phenylene group optionally having a substituent or the cyclohexane-1,4-diyl group optionally having a substituent include an alkyl group having 1 to 4 carbon atoms such as a methyl group, an ethyl group, and a butyl group, a cyano group, and a halogen atom such as a chlorine atom and a fluorine atom. It is preferably unsubstituted.

Y^{1z} is preferably —CH₂CH₂—, —CH₂O—, —CH₂CH₂O—, —COO—, —O—CO—O—, a single bond, —N═N—, —CR^{az}=CR^{bz}—, —C≡C—, —CR^{az}═N—, or —CO—NR^{az}—. R^{az} and R^{bz} each independently represent a hydrogen atom or an alkyl group having 1 to 4 carbon atoms.

Y^{1z} is more preferably —CH₂CH₂—, —COO—, or a single bond, and in a case where a plurality of Y^{1z}'s are present, Y^{1z} that is bonded to X^{2z} is more preferably —CH₂CH₂— or —CH₂O—. In a case where all of X^{1z} and X^{2z} have the same structure, it is preferable that two or more Y^{1z}'s having different bonding methods are present. In a case where a plurality of Y^{1z}'s having different bonding methods are present, an asymmetric structure is formed, so that smectic liquid crystallinity tends to be exhibited.

U^{2z} is the above-described polymerizable group. U^{1z} is a hydrogen atom or a polymerizable group. As the polymerizable group represented by U^{2z} and U^{1z}, a (meth)acryloyloxy group is preferable.

Examples of the alkanediyl group represented by V^{1z} and V^{2z} include a methylene group, an ethylene group, a propane-1,3-diyl group, a butane-1,3-diyl group, a butane-1,4-diyl group, a pentane-1,5-diyl group, a hexane-1,6-diyl group, a heptane-1,7-diyl group, an octane-1,8-diyl group, a decane-1,10-diyl group, a tetradecane-1,14-diyl group, and an icosane-1,20-diyl group. V^{1z} and V^{2z} are preferably an alkanediyl group having 2 to 12 carbon atoms and more preferably an alkanediyl group having 6 to 12 carbon atoms.

Examples of the substituent which may be included in the alkanediyl group include a cyano group and a halogen atom, but the alkanediyl group is preferably unsubstituted and more preferably an unsubstituted linear alkanediyl group.

W^{1z} and W^{2z} each independently represent preferably a single bond, —O—, —S—, —COO—, or —O—CO—O—, and more preferably a single bond or —O—.

The polymerizable liquid crystal compound (Z) preferably has an asymmetric molecular structure in the molecular structure, and specifically, a polymerizable liquid crystal compound having a partial structure represented by Formula (A-a) to Formula (A-i) is more preferable. From the viewpoint of easily exhibiting higher-order smectic liquid crystallinity, it is more preferable to have a partial structure represented by Formula (A-a), Formula (A-b), or Formula (A-c). In Formulae (A-a) to (A-i), * represents a bonding position.

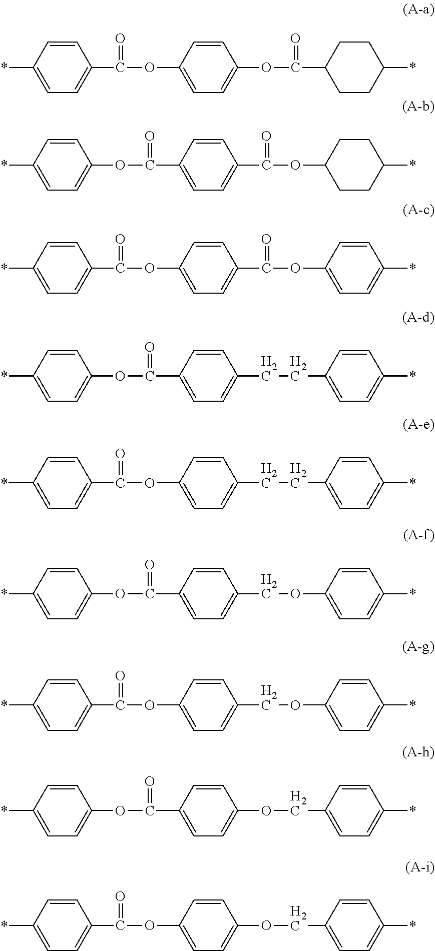

Specific examples of the polymerizable liquid crystal compound (Z) include compounds represented by Formula (A-1) to Formula (A-26). In a case where the polymerizable liquid crystal compound (Z) has a cyclohexane-1,4-diyl group, the cyclohexane-1,4-diyl group is preferably a trans form.

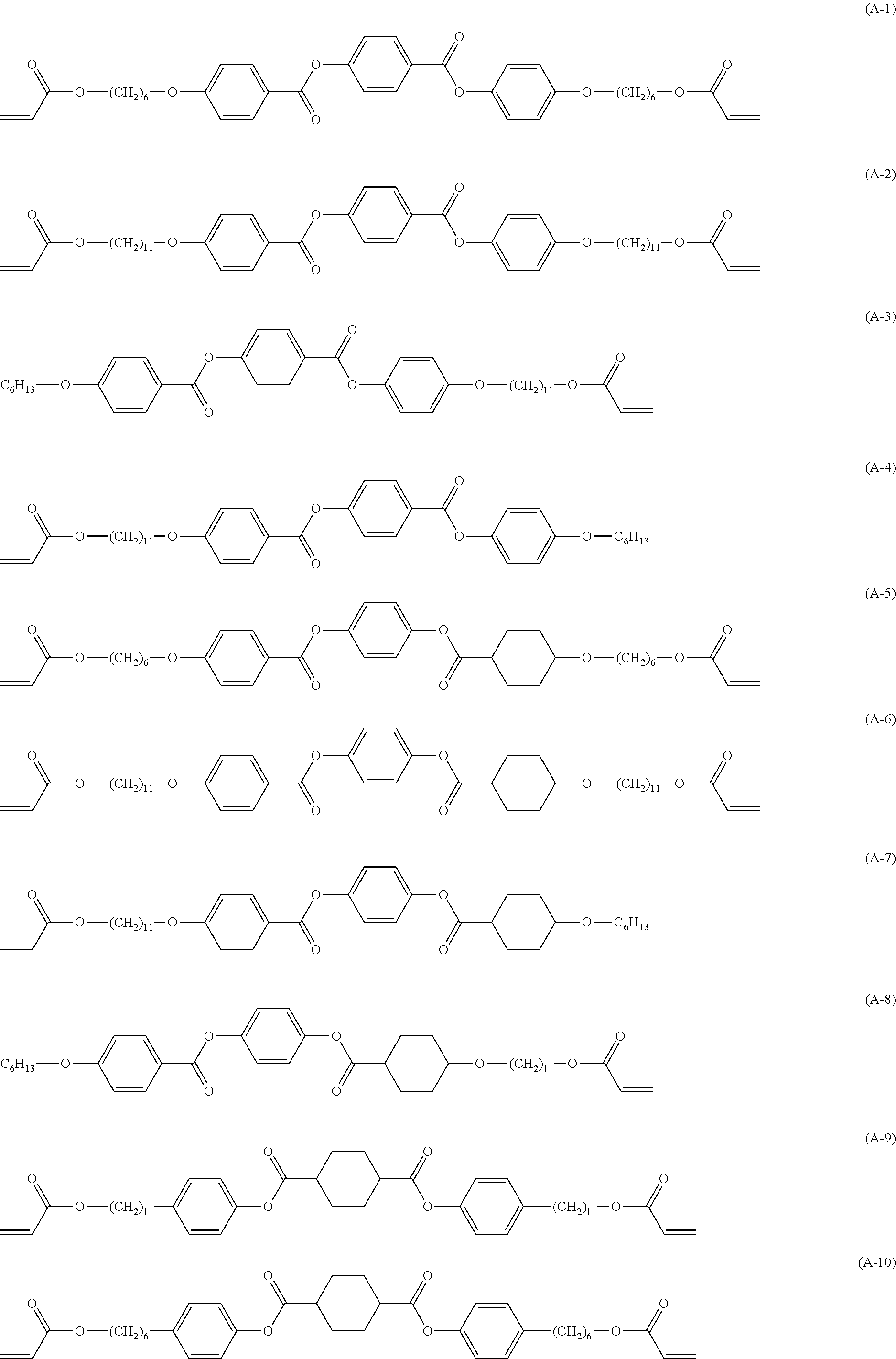

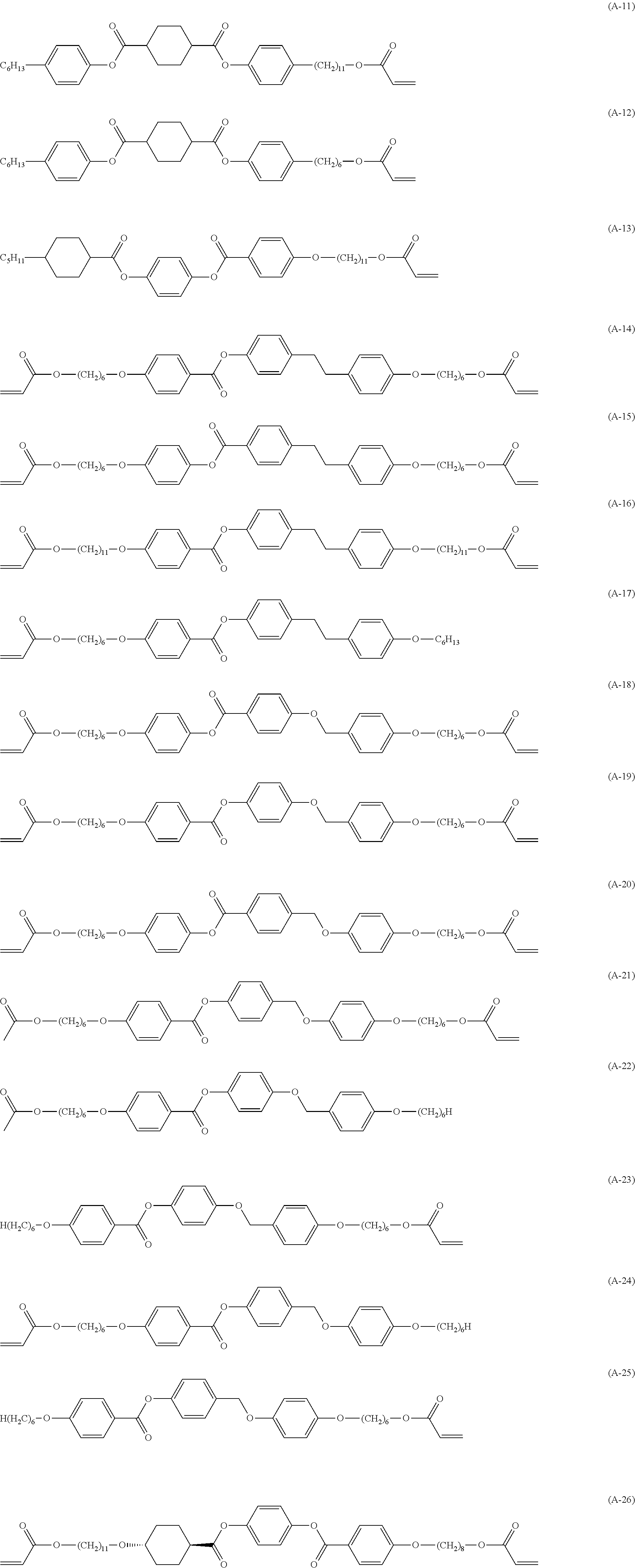

The polymerizable liquid crystal compound (Z) can be produced by, for example, a known method described in Lub et al., Recl. Trav. Chim. Pays-Bas, 115, 321 to 328 (1996) or JP4719156B.

A content of the liquid crystal compound in the light absorption anisotropic film is preferably 25 to 2,000 parts by mass, more preferably 100 to 1,300 parts by mass, and still more preferably 200 to 900 parts by mass with respect to 100 parts by mass of the content of the dichroic substance. In a case where the content of the liquid crystal compound is within the above-described range, the alignment degree of the dichroic substance is further improved. The light absorption anisotropic layer may contain only one or two or more kinds of liquid crystal compounds. In a case where the light absorption anisotropic layer contains two or more kinds of liquid crystal compounds, the content of the liquid crystal compounds denotes the total content of the liquid crystal compounds.

### [Dichroic Substance]

The light absorption anisotropic film contains a dichroic substance.

In the present specification, the dichroic substance means a coloring agent having different absorbances depending on directions. The dichroic substance may or may not exhibit liquid crystallinity. In a case where the dichroic azo coloring agent compound exhibits liquid crystallinity, any of nematic properties or smectic properties may be exhibited. The temperature range in which the liquid crystal phase is exhibited is preferably room temperature (approximately 20° C. to 28° C.) to 300° C., and from the viewpoint of handleability and manufacturing suitability, more preferably 50° C. to 200° C.

In the light absorption anisotropic film, the dichroic substance may be fixed in an aligned state. For example, in a case where the dichroic substance is fixed in an aligned state by polymerization in the light absorption anisotropic film, the light absorption anisotropic film typically contains a cured substance cured in a state where the dichroic substance is aligned.

The dichroic substance is not particularly limited, and examples thereof include a visible light absorbing substance (dichroic coloring agent), a luminescent substance (fluorescent substance, phosphorescent substance), an ultraviolet absorbing substance, an infrared absorbing substance, a nonlinear optical substance, a carbon nanotube, and an inorganic substance (for example, a quantum rod), and a dichroic substance (dichroic coloring agent) known in the related art can be used.

As the dichroic substance, a dichroic azo coloring agent, a dichroic acridine coloring agent, a dichroic oxazine coloring agent, a dichroic cyanine coloring agent, a dichroic naphthalene coloring agent, a dichroic anthraquinone coloring agent, or the like is preferable, and among these, a dichroic azo coloring agent is more preferable.

As the dichroic azo coloring agent, a dichroic azo coloring agent used in a so-called coating type polarizer can be used. The dichroic azo coloring agent is not particularly limited, and a dichroic azo coloring agent known in the related art can be used.

Among these, as the dichroic azo coloring agent, a bisazo coloring agent or a trisazo coloring agent is preferable.

The dichroic azo coloring agent may have a polymerizable group. In a case where the dichroic azo coloring agent has a polymerizable group, the light absorption anisotropic film typically contains the dichroic azo coloring agent in a state where the alignment is fixed by polymerization.

Examples of the dichroic azo coloring agent include a compound represented by Formula (A) (hereinafter, also referred to as “compound (A)”). In a case where the compound (A) has a polymerizable group, the light absorption anisotropic film typically contains a polymer of the compound (A).

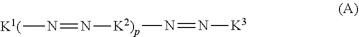

In Formula (A), K¹ and K³ each independently represent a phenyl group which may have a substituent, a naphthyl group which may have a substituent, or a monovalent heterocyclic group which may have a substituent. K² represents a p-phenylene group optionally having a substituent, a naphthalene-1,4-diyl group optionally having a substituent, or a divalent heterocyclic group optionally having a substituent. p represents an integer of 1 to 4. In a case where p is an integer of 2 or more, a plurality of K²'s may be the same as or different from each other. In addition, the —N═N— bond may be substituted with a —C═C—, —COO—, —NHCO—, or —N═CH— bond in a range where absorption is exhibited in the visible range.

Examples of the monovalent heterocyclic group include groups obtained by removing one hydrogen atom from a heterocyclic compound such as quinoline, thiazole, benzothiazole, thienothiazole, imidazole, benzimidazole, oxazole, and benzoxazole.

Examples of the divalent heterocyclic group include groups obtained by removing two hydrogen atoms from the above heterocyclic compound.

As the above-described heterocyclic compound, an aromatic heterocyclic compound is preferable. That is, the monovalent heterocyclic group is preferably a monovalent aromatic heterocyclic group, and the divalent heterocyclic group is preferably a divalent aromatic heterocyclic group.

The substituents which may be optionally included in the phenyl group, the naphthyl group, and the monovalent heterocyclic group in K¹ and K³, and in the p-phenylene group, the naphthalene-1,4-diyl group, and the divalent heterocyclic group in K² are not particularly limited, and examples thereof include an alkyl group having 1 to 20 carbon atoms, in which at least one —CH₂— may be substituted with a group selected from —CO— or —O—; an alkyl group having 1 to 20 carbon atoms, which has a polymerizable group and in which at least one —CH₂— may be substituted with a group selected from —CO— or —O—; an alkenyl group having 1 to 4 carbon atoms; an alkoxy group having 1 to 20 carbon atoms, in which at least one —CH₂— may be substituted with a group selected from —CO— or —O—; an alkoxy group having 1 to 20 carbon atoms, which has a polymerizable group and in which at least one —CH₂— may be substituted with a group selected from —CO— or —O—; a fluorinated alkyl group having 1 to 4 carbon atoms, such as a trifluoromethyl group; a cyano group; a nitro group; a halogen atom; and a substituted or unsubstituted amino group.

In addition, examples of the polymerizable group include a (meth)acryloyl group and a (meth)acryloyloxy group.

In addition, the substituted amino group represents any one of —NH(R^{a}) or —N(R^{a})₂. R^{a} represents a substituent. The substituent represented by R^{a} is not particularly limited, and examples thereof include an alkyl group having 1 to 6 carbon atoms, in which at least one —CH₂— may be substituted with a group selected from —CO— or —O—; and an alkyl group having 1 to 6 carbon atoms, which has a polymerizable group and in which at least one —CH₂— may be substituted with a group selected from —CO— or —O—. In addition, in the group represented by —N(R^{a})₂, two R^{a}'s may be bonded to each other (for example, an aspect in which two R^{a}'s are bonded to each other to form an alkanediyl group having 2 to 8 carbon atoms is exemplified). In addition, the unsubstituted amino group is —NH₂.

From the viewpoint that the effect of the present invention is more excellent, as the substituents which may be optionally included in the phenyl group, the naphthyl group, and the monovalent heterocyclic group in K¹ and K³, among these, an alkyl group having 1 to 20 carbon atoms, in which at least one —CH₂— may be substituted with a group selected from —CO— or —O—; an alkyl group having 1 to 20 carbon atoms, which has a polymerizable group and in which at least one —CH₂— may be substituted with a group selected from —CO— or —O—; an alkoxy group having 1 to 20 carbon atoms, in which at least one —CH₂— may be substituted with a group selected from —CO— or —O—; an alkoxy group having 1 to 20 carbon atoms, which has a polymerizable group and in which at least one —CH₂— may be substituted with a group selected from —CO— or —O—; and a substituted amino group represented by —N(R^{a})₂(here, R^{a} represents an alkyl group having 1 to 6 carbon atoms, in which at least one —CH₂— may be substituted with a group selected from —CO— or —O—, or an alkyl group having 1 to 6 carbon atoms, which has a polymerizable group and in which at least one —CH₂— may be substituted with a group selected from —CO— or —O—) are preferable.

From the viewpoint that the effect of the present invention is more excellent, as the substituents which may be optionally included in the phenyl group, the naphthyl group, and the monovalent heterocyclic group in K¹ and K³, among these, it is preferable to have at least one site (hereinafter, also referred to as “—COO— substituted site”) substituted with —COO— (ester bond). Specific examples of the substituent include an alkyl group having 1 to 20 carbon atoms and having a —COO— substitution site (preferably an alkyl group having 2 to 20 carbon atoms and having a —COO— substitution site, more preferably an alkyl group having 6 to 20 carbon atoms and having a —COO— substitution site); an alkyl group having 1 to 20 carbon atoms, having a polymerizable group, and having a —COO— substitution site (preferably an alkyl group having 2 to 20 carbon atoms, having a polymerizable group, and having a —COO— substitution site, more preferably an alkyl group having 6 to 20 carbon atoms, having a polymerizable group, and having a —COO— substitution site); an alkoxy group having 1 to 20 carbon atoms and having a —COO— substitution site (preferably an alkoxy group having 3 to 20 carbon atoms and having a —COO— substitution site, more preferably an alkoxy group having 6 to 20 carbon atoms and having a —COO— substitution site); an alkoxy group having 1 to 20 carbon atoms, having a polymerizable group, and having a —COO— substitution site (preferably an alkoxy group having 3 to 20 carbon atoms, having a polymerizable group, and having a —COO— substitution site, more preferably an alkoxy group having 6 to 20 carbon atoms, having a polymerizable group, and having a —COO— substitution site); and a substituted amino group represented by —N(R^{a})(R^{b}) (wherein R^{a} represents an alkyl group having 1 to 6 carbon atoms and having a —COO— substitution site, an alkyl group having 1 to 6 carbon atoms, having a polymerizable group, and having a —COO— substitution site, or an alkoxy group having 1 to 6 carbon atoms, having a polymerizable group, and having a —COO— substitution site (preferably an alkyl group having 2 to 6 carbon atoms and having a —COO— substitution site, an alkyl group having 2 to 6 carbon atoms, having a polymerizable group, and having a —COO— substitution site, or an alkoxy group having 3 to 6 carbon atoms, having a polymerizable group, and having a —COO— substitution site)). R^{b} represents an alkyl group having 1 to 20 carbon atoms (preferably 1 to 10 carbon atoms and more preferably 1 to 6 carbon atoms).

Among the compounds (i), a compound represented by any one of Formulae (i-1) to (i-8) is preferable.

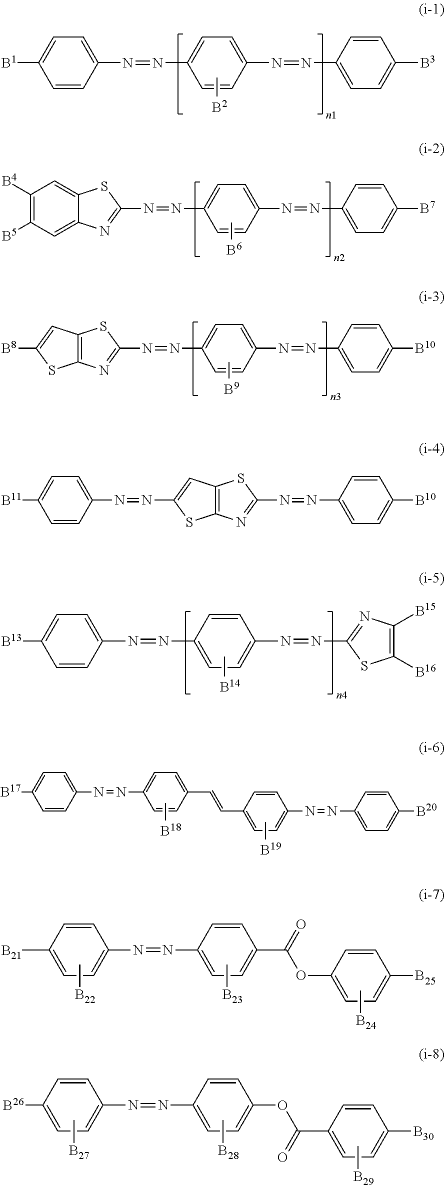

In Formulae (A-1) to (A-8), B¹ to B³⁰ each independently represent a hydrogen atom or a substituent. Specific examples of the substituent represented by B¹ to B³⁰ are the same as those exemplified as an example of the substituents which may be optionally included in the phenyl group, the naphthyl group, and the monovalent heterocyclic group in K¹ and K³, and in the p-phenylene group, the naphthalene-1,4-diyl group, and the divalent heterocyclic group in K² in the upper part.
n1 to n4 each independently represent an integer of 0 to 3. In a case where n1 is 2 or more, a plurality of B²'s may be the same as or different from each other, in a case where n2 is 2 or more, a plurality of B⁶'s may be the same as or different from each other, in a case where n3 is 2 or more, a plurality of B⁹'s may be the same as or different from each other, and in a case where n4 is 2 or more, a plurality of B¹'s may be the same as or different from each other.

As the dichroic acridine coloring agent, the dichroic oxazine coloring agent, the dichroic cyanine coloring agent, the dichroic naphthalene coloring agent, the dichroic azo coloring agent, and the dichroic anthraquinone coloring agent, compounds disclosed in paragraphs 0083 to 0088 of JP2022-145604A can also be suitably used. In addition, as the dichroic substance, compounds disclosed in WO2018/186503A, WO2019/189345A, and WO2018/124198A can also be suitably used.

A molecular weight (in a case of having a molecular weight distribution, a weight-average molecular weight) of the dichroic substance is typically 300 to 2,000, and preferably 400 to 1,000.

The light absorption anisotropic film may contain one kind of dichroic substance alone or two or more kinds thereof, but from the viewpoint of more excellent alignment property, it is preferable to contain two or more kinds thereof and preferable to contain three or more kinds thereof.

A content of the dichroic substance in the light absorption anisotropic film is preferably 1% by mass or more, more preferably 5% by mass or more, and still more preferably 10% by mass or more with respect to the total mass of the light absorption anisotropic film. For example, the upper limit value thereof is preferably 50% by mass or less, more preferably 45% by mass or less, and still more preferably 40% by mass or less.

In a case where two or more kinds of dichroic substances are contained, the content of the dichroic substance means the total content of the dichroic substances.

### [Phenolic Compound]

The light absorption anisotropic film contains a compound represented by Formula (1) (specific phenol compound) as the phenol compound. Hereinafter, the specific phenol compound will be described.

### <Compound Represented by Formula (1)>

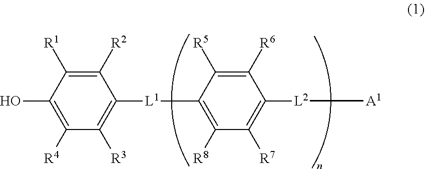

In Formula (1), R¹ to R⁸ each independently represent a hydrogen atom, a hydroxyl group, an alkyl group, or an alkoxy group.

The alkyl group represented by R¹ to R⁸ is preferably linear or branched.

The number of carbon atoms in the alkyl group represented by R¹ to R⁸ is preferably 1 to 20, more preferably 1 to 15, still more preferably 1 to 10, particularly preferably 1 to 6, and most preferably 1 to 3.

The alkoxy group represented by R¹ to R⁸ is preferably linear or branched.

The number of carbon atoms in the alkoxy group represented by R¹ to R⁸ is preferably 1 to 20, more preferably 1 to 15, still more preferably 1 to 10, particularly preferably 1 to 6, and most preferably 1 to 3.

From the viewpoint that the effect of the present invention is more excellent, R¹ to R⁸ are preferably a methyl group or a hydrogen atom, and more preferably a hydrogen atom.

In Formula (1), L¹ represents a single bond or a divalent linking group having no ring structure.

The divalent linking group having no ring structure is a divalent linking group having no aromatic ring structure or alicyclic structure, and specific examples thereof include a chain-like (linear or branched) divalent linking group.

Specific examples of the divalent linking group having no ring structure represented by L¹ include a divalent linking group selected from the group consisting of —O—, —S—, —CO—, —NR^{T}—, —C═N—, —N═N—, a chain-like alkylene group, and a combination thereof.

The above-described chain-like alkylene group may be linear or branched. The number of carbon atoms in the above-described chain-like alkylene group is preferably 1 to 20, more preferably 1 to 12, and still more preferably 1 to 6.

The number of atoms other than the hydrogen atom in the divalent linking group represented by L¹ is preferably 1 to 20, more preferably 1 to 12, and still more preferably 1 to 6.

R^{T} represents a hydrogen atom or a chain-like alkyl group having 1 to 7 carbon atoms, and a hydrogen atom is preferable.

From the viewpoint that the effect of the present invention is more excellent, L¹ is preferably a single bond, —COO—, or —O—, and more preferably a single bond or —O—.

In Formula (1), L² represents a single bond or a divalent linking group.

Specific examples of the divalent linking group represented by L² include a divalent linking group selected from the group consisting of —O—, —S—, —CO—, —NR^{T}—, —C═N—, —N═N—, an alkylene group, and a combination thereof.

The above-described alkylene group may be linear, branched, or cyclic, and is preferably chain-like (linear or branched). The alkylene group preferably has 1 to 20 carbon atoms, more preferably has 1 to 12 carbon atoms, and still more preferably has 1 to 6 carbon atoms.

The number of atoms other than the hydrogen atom in the divalent linking group represented by L² is preferably 1 to 20, more preferably 1 to 12, and still more preferably 1 to 6.

R^{T} represents a hydrogen atom or an alkyl group having 1 to 7 carbon atoms, and among these, a hydrogen atom is preferable. The alkyl group having 1 to 7 carbon atoms represented by R^{T} may be linear, branched, or cyclic, and is preferably chain-like (linear or branched).

From the viewpoint that the effect of the present invention is more excellent, L² is preferably a single bond, —COO—, or —O—, and more preferably a single bond or —O—.

In Formula (1), A¹ represents a group represented by Formula (2), a hydroxyl group, an alkyl group, or an alkoxy group.

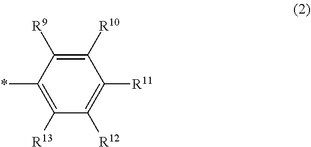

In Formula (2), R⁹ to R¹³ each independently represent a hydrogen atom, a hydroxyl group, an alkyl group, or an alkoxy group. * represents a bonding position.

The alkyl group represented by R⁹ to R¹³ is preferably linear or branched.

The number of carbon atoms in the alkyl group represented by R⁹ to R¹³ is preferably 1 to 20, more preferably 1 to 15, and still more preferably 1 to 10.

The alkoxy group represented by R⁹ to R¹³ is preferably linear or branched.

The number of carbon atoms in the alkoxy group represented by R⁹ to R¹³ is preferably 1 to 20, more preferably 1 to 15, and still more preferably 1 to 10.

From the viewpoint that the effect of the present invention is more excellent, R⁹, R¹⁰, R¹², and R¹³ are preferably a methyl group or a hydrogen atom, and more preferably a hydrogen atom.

From the viewpoint that the effect of the present invention is more excellent, R¹¹ is preferably an alkyl group or an alkoxy group.

The above-described alkyl group represented by A¹ may be linear, branched, or cyclic. The number of carbon atoms in the alkyl group represented by A¹ is preferably 1 to 20, more preferably 1 to 15, and still more preferably 1 to 10.

The alkoxy group represented by A¹ is preferably linear or branched.

The number of carbon atoms in the alkoxy group represented by A¹ is preferably 1 to 20, more preferably 1 to 15, and still more preferably 1 to 10.

Among these, A¹ is preferably a group represented by Formula (2), an alkyl group, or an alkoxy group.

In Formula (1), n represents an integer of 0 to 2. From the viewpoint that the effect of the present invention is more excellent, n is preferably 0 or 1, and more preferably 0.

In Formula (1), in a case where n represents 2, a plurality of R⁵'s, a plurality of R⁶'s, a plurality of R⁷'s, a plurality of R⁸'s, and a plurality of L²'s may be the same as or different from each other.

A molecular weight of the specific phenol compound is preferably 600 or less, more preferably 500 or less, and still more preferably 450 or less.

From the viewpoint that the effect of the present invention is more excellent, the number of hydroxyl groups in the specific phenol compound is preferably 1.

Hereinafter, specific examples of the specific phenol compound will be described, but the present invention is not limited thereto.

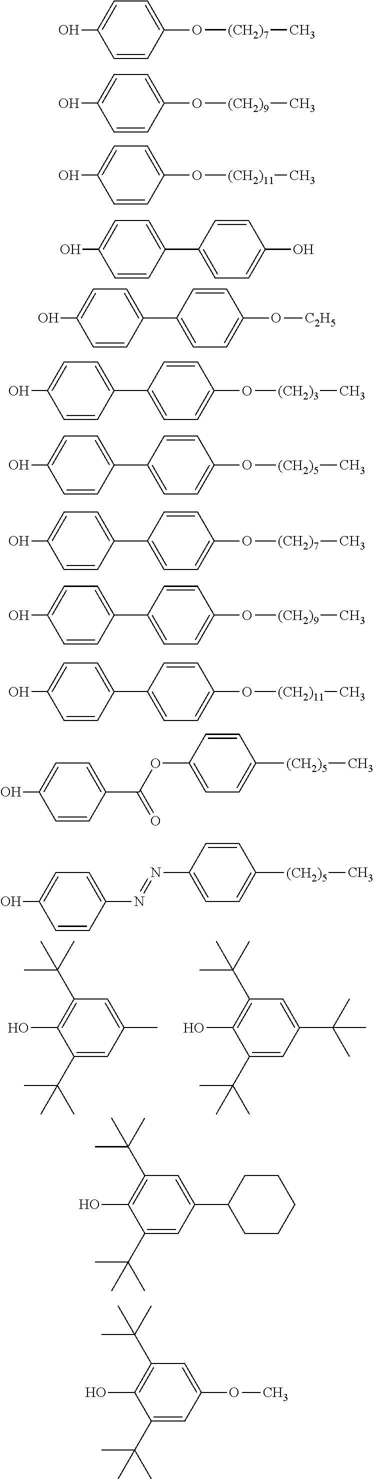

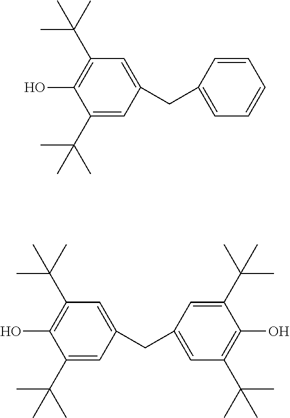 [SMILES: CC(C)(C)c1cc(Cc2ccccc2)cc(C(C)(C)C)c1O ; CC(C)(C)c1cc(Cc2cc(C(C)(C)C)c(O)c(C(C)(C)C)c2)cc(C(C)(C)C)c1O]

A content of the specific phenol compound in the light absorption anisotropic film is preferably 0.01% by mass or more, more preferably 0.1% by mass or more, and still more preferably 0.5% by mass or more with respect to the total mass of the light absorption anisotropic film. The upper limit value thereof is preferably 10% by mass or less, more preferably 5% by mass or less, and still more preferably 3% by mass or less.

The specific phenol compound may be contained alone or in combination of two or more kinds thereof. In a case where two or more kinds of specific phenol compounds are contained, the content of the specific phenol compound means the total content of the specific phenol compounds.

### [Other Components]

In the light absorption anisotropic film, in addition to the above-described components, an alignment promoter (vertical alignment agent), an adhesion improver, a plasticizer, a polymer, or the like may be contained.

### <Alignment Promoter (Vertical Alignment Agent)>

From the viewpoint that the effect of the present invention is excellent, the light absorption anisotropic film preferably contains an alignment promoter (vertical alignment agent).

Examples of the alignment promoter (vertical alignment agent) include an ionic compound and a silane compound.

### (Ionic Compound)

The above-described ionic compound is preferably an ionic compound consisting of a non-metal atom.

Examples of the ionic compound include an onium salt (specifically, a quaternary ammonium salt, a tertiary sulfonium salt, a quaternary phosphonium salt, and the like). Among these, from the viewpoint that the vertical alignment property of the liquid crystal compound is more excellent, a quaternary phosphonium salt or a quaternary ammonium salt is preferable, and a quaternary ammonium salt is more preferable.

In addition, the above-described onium salt may be a compound having two or more salt structural sites in the molecule. In addition, the above-described onium salt may be an oligomer or a polymer.

A molecular weight of the ionic compound is not particularly limited, but from the viewpoint that the vertical alignment property of the liquid crystal compound is more excellent, it is preferably 100 to 10,000, more preferably 100 to 5,000, and still more preferably 100 to 3,000.

The cationic component of the ionic compound may be any of an inorganic cation or an organic cation, but from the viewpoint of being less likely to generate alignment defects, an organic cation is preferable.

Examples of the organic cation include an imidazolium cation, a pyridinium cation, an ammonium cation, a sulfonium cation, and a phosphonium cation.

The ionic compound typically has an anionic component that is paired with the above-described cationic component. The anionic component may be any of an inorganic anion or an organic anion, but from the viewpoint of being less likely to generate alignment defects, an organic anion is preferable.

Specific examples of the anionic component include the following.
chloride anion [Cl⁻], bromide anion [Br⁻], iodide anion [I⁻], tetrachloroaluminate anion [AlCl₄⁻], heptachlorodi-aluminate anion [Al₂Cl₇⁻], tetrafluoroborate anion [BF₄⁻], hexafluorophosphate anion [PF₆⁻], perchlorate anion [ClO₄⁻], nitrate anion [NO₃⁻], acetate anion [CH₃COO⁻], trifluoroacetate anion [CF₃COO⁻], fluorosulfonate anion [FSO₃⁻], methanesulfonate anion [CH₃SO₃⁻], trifluoromethanesulfonate anion [CF₃SO₃⁻], p-toluenesulfonate anion [p-CH₃C₆H₄SO₃⁻], bis(fluorosulfonyl)imide anion [(FSO₂)₂N⁻], bis(trifluoromethanesulfonyl)imide anion [(CF₃SO₂)₂N⁻], tris(trifluoromethanesulfonyl)methanide anion [(CF₃SO₂)₃C⁻], hexafluoroarsenate anion [AsF₆⁻], hexafluoroantimonate anion [SbF₆⁻], hexafluoroniobate anion [NbF₆⁻], hexafluorotantalate anion [TaF₆⁻], dimethylphosphinite anion [(CH₃)₂POO⁻], (poly)hydrofluorofluoride anion [F(HF)ₙ⁻](for example, n represents an integer of 1 to 3), dicyanamide anion [(CN)₂N⁻], thiocyanate anion [SCN], perfluorobutanesulfonate anion [C₄F₉SO₃⁻], bis(pentafluoroethanesulfonyl)imide anion [(C₂F₅SO₂)₂N⁻], perfluorobutanoate anion [C₃F₇COO⁻], and (trifluoromethanesulfonyl)(trifluoromethanecarbonyl)imide anion [(CF₃SO₂)(CF₃CO)N⁻].

Specific examples of the ionic compound can be appropriately selected from a combination of the above-described cationic component and the anionic component. Examples of the compound that is a specific combination of the cationic component and the anionic component include the following.

N-hexylpyridinium hexafluorophosphate; N-octylpyridinium hexafluorophosphate; N-methyl-4-hexylpyridinium hexafluorophosphate; N-butyl-4-methylpyridinium hexafluorophosphate; N-octyl-4-methylpyridinium hexafluorophosphate; N-hexylpyridinium bis(fluorosulfonyl)imide; N-octylpyridinium bis(fluorosulfonyl)imide; N-methyl-4-hexylpyridinium bis(fluorosulfonyl)imide; N-butyl-4-methylpyridinium bis(fluorosulfonyl)imide; N-octyl-4-methylpyridinium bis(fluorosulfonyl)imide; N-hexylpyridinium bis(trifluoromethanesulfonyl)imide; N-octylpyridinium bis(trifluoromethanesulfonyl)imide; N-methyl-4-hexylpyridinium bis(trifluoromethanesulfonyl)imide; N-butyl-4-methylpyridinium bis(trifluoromethanesulfonyl)imide; N-octyl-4-methylpyridinium bis(trifluoromethanesulfonyl)imide; N-hexylpyridinium p-toluenesulfonate; N-octylpyridinium p-toluenesulfonate; N-methyl-4-hexylpyridinium p-toluenesulfonate; N-butyl-4-methylpyridinium p-toluenesulfonate; N-octyl-4-methylpyridinium p-toluenesulfonate; and the like,
imidazolium salts such as 1-ethyl-3-methylimidazolium hexafluorophosphate, 1-ethyl-3-methylimidazolium bis(fluorosulfonyl)imide, 1-ethyl-3-methylimidazolium bis(trifluoromethanesulfonyl)imide, 1-ethyl-3-methylimidazolium p-toluenesulfonate, and 1-butyl-3-methylimidazolium methanesulfonate,
pyrrolidinium salts such as N-butyl-N-methylpyrrolidinium hexafluorophosphate, N-butyl-N-methylpyrrolidinium bis(fluorosulfonyl)imide, N-butyl-N-methylpyrrolidinium bis(trifluoromethanesulfonyl)imide, and N-butyl-N-methylpyrrolidinium p-toluenesulfonate,
tetra-n-butylammonium hexafluorophosphate; tetra-n-butylammonium bis(fluorosulfonyl)imide; tetrahexylammonium bis(fluorosulfonyl)imide;
trimethyloctylammonium bis(fluorosulfonyl)imide; (2-hydroxyethyl)trimethylammonium bis(fluorosulfonyl)imide; tetra-n-butylammonium bis(trifluoromethanesulfonyl)imide;
tetrahexylammonium bis(trifluoromethanesulfonyl)imide; trimethyloctylammonium bis(trifluoromethanesulfonyl)imide; (2-hydroxyethyl)trimethylammonium bis(trifluoromethanesulfonyl)imide; tetra-n-butylammonium p-toluenesulfonate; tetrahexylammonium p-toluenesulfonate; trimethyloctylammonium p-toluenesulfonate; (2-hydroxyethyl)trimethylammonium p-toluenesulfonate; (2-hydroxyethyl)trimethylammonium dimethylphosphinate; 1-(3-trimethoxysilylpropyl)-1,1,1-tributylammonium bis(trifluoromethanesulfonyl)imide; 1-(3-trimethoxysilylpropyl)-1,1,1-trimethylammonium bis(trifluoromethanesulfonyl)imide; 1-(3-trimethoxysilylbutyl)-1,1,1-tributylammonium bis(trifluoromethanesulfonyl)imide; 1-(3-trimethoxysilylbutyl)-1,1,1-trimethylammonium bis(trifluoromethanesulfonyl)imide; N-((3-triethoxysilylpropyl)carbamoyloxyethyl)-N,N,N-trimethylammonium bis(trifluoromethanesulfonyl)imide; N-[2-{3-(3-trimethoxysilylpropylamino)-1-oxopropoxy}ethyl]-N,N,N-trimethylammonium bis(trifluoromethanesulfonyl)imide; and the like.
tributyl(2-methoxyethyl)phosphonium bis(trifluoromethanesulfonyl)imide; tributylmethylphosphonium bis(trifluoromethanesulfonyl)imide; 1,1,1-trimethyl-1-[(trimethoxysilyl)methyl]phosphonium bis(trifluoromethanesulfonyl)imide; 1,1,1-trimethyl-1-[2-(trimethoxysilyl)ethyl]phosphonium bis(trifluoromethanesulfonyl)imide; 1,1,1-trimethyl-1-[3-(trimethoxysilyl)propyl]phosphonium bis(trifluoromethanesulfonyl)imide; 1,1,1-trimethyl-1-[4-(trimethoxysilyl)butyl]phosphonium bis(trifluoromethanesulfonyl)imide; 1,1,1-tributyl-1-[(trimethoxysilyl)methyl]phosphonium bis(trifluoromethanesulfonyl)imide; 1,1,1-tributyl-1-[2-(trimethoxysilyl)ethyl]phosphonium bis(trifluoromethanesulfonyl)imide; 1,1,1-tributyl-1-[3-(trimethoxysilyl)propyl]phosphonium bis(trifluoromethanesulfonyl)imide; and the like.

In addition, from the viewpoint of further improving the vertical alignment property of the liquid crystal compound, the ionic compound is also preferably a structure in which the molecular structure of the cationic moiety has a Si element and/or an F element. In a case where the ionic compound has a Si element and/or an F element in the molecular structure of the cationic moiety, the ionic compound is likely to segregate on the surface of the light absorption anisotropic film, and the vertical alignment property of the liquid crystal compound is likely to be more excellent. Among these, as the ionic compound in which all of the constituent elements are non-metal elements, the following ionic compounds (I-i) to (I-iii) are preferable.

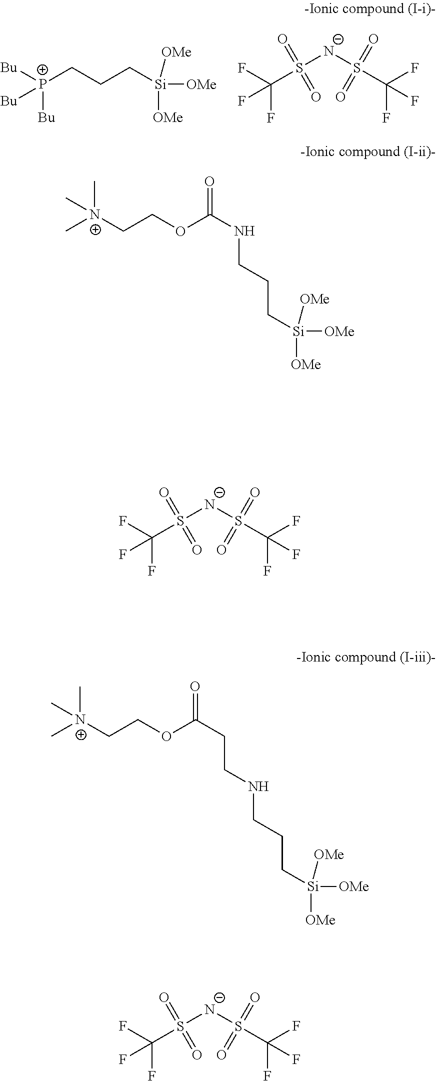

In addition, from the viewpoint of further improving the vertical alignment property of the liquid crystal compound, the ionic compound is also preferably a structure having a long-chain alkyl group. Specifically, it is preferable that the ionic compound satisfies a relationship of Formula (I-1).

$$5 < M < 16 \qquad ( I ‐ 1 )$$

In Formula (I-1), M is represented by Formula (I-2).

M=(number of covalent bonds from an atom having a positive charge to a molecular chain end in a substituent directly bonded to the atom having a positive charge and having the largest number of covalent bonds to the molecular chain end)/(number of atoms having a positive charge) (I-2)

In a case where the ionic compound satisfies the relationship of Formula (I-1), the vertical alignment property of the liquid crystal compound can be effectively improved.

In a case where two or more atoms having a positive charge are present in the molecule of the ionic compound, in a substituent having two or more atoms having a positive charge, the number of covalent bonds from an atom having a positive charge as a base point to the closest atom having a positive charge other than the atom having a positive charge is defined as the “number of covalent bonds from an atom having a positive charge to a molecular chain end” in the definition of M. In addition, in a case where the ionic compound is an oligomer or a polymer having two or more repeating units, a constitutional unit is considered as one molecule, and M is calculated. In a case where an atom having a positive charge is incorporated into a ring structure, the number of covalent bonds to the atom having a positive charge via the ring structure or the number of covalent bonds to the end of a substituent bonded to the ring structure, in which the number of covalent bonds is larger, is defined as the “number of covalent bonds from an atom having a positive charge to a molecular chain end” in the definition of M.

A content of the ionic compound in the light absorption anisotropic film is preferably 0.01% to 5% by mass, more preferably 0.05% to 4% by mass, and still more preferably 0.1% to 3% by mass with respect to the total mass of the light absorption anisotropic film. The ionic compound may be contained only one kind or two or more kinds. In a case where two or more kinds of ionic compounds are contained, the content of the ionic compound means the total content of the ionic compounds.

### (Silane Compound)

The silane compound is preferably a nonionic silane compound, and preferably a nonionic compound containing a Si element.

Examples of the nonionic silane compound include a silicon polymer such as polysilane; a silicone resin such as a silicone oil and a silicone resin; a silicone oligomer; and a compound selected from the group consisting of a silane coupling agent, a hydrolyzate thereof, and a hydrolytic condensate thereof, such as silsesquioxane siloxane and alkoxysilane. From the viewpoint that the effect of the present invention is more excellent and the adhesiveness to the adjacent layer is more excellent, the silane compound is preferably a compound selected from the group consisting of a silane coupling agent, a hydrolyzate thereof, and a hydrolytic condensate thereof.

Examples of the composition of the silicone oligomer (hereinafter, the copolymer composition is shown in a form of monomer-monomer) include copolymers containing a mercaptopropyl group, such as a 3-mercaptopropyltrimethoxysilane-tetramethoxysilane copolymer, a 3-mercaptopropyltrimethoxysilane-tetraethoxysilane copolymer, a 3-mercaptopropyltriethoxysilane-tetramethoxysilane copolymer, and a 3-mercaptopropyltriethoxysilane-tetraethoxysilane copolymer; copolymers containing a mercaptomethyl group, such as a mercaptomethyltrimethoxysilane-tetramethoxysilane copolymer, a mercaptomethyltrimethoxysilane-tetraethoxysilane copolymer, a mercaptomethyltriethoxysilane-tetramethoxysilane copolymer, and a mercaptomethyltriethoxysilane-tetraethoxysilane copolymer; copolymers containing a methacryloyloxypropyl group, such as a 3-methacryloyloxypropyltrimethoxysilane-tetramethoxysilane copolymer, a 3-methacryloyloxypropyltrimethoxysilane-tetraethoxysilane copolymer, a 3-methacryloyloxypropyltriethoxysilane-tetramethoxysilane copolymer, a 3-methacryloyloxypropyltriethoxysilane-tetraethoxysilane copolymer, a 3-methacryloyloxypropylmethyldimethoxysilane-tetramethoxysilane copolymer, a 3-methacryloyloxypropylmethyldimethoxysilane-tetraethoxysilane copolymer, a 3-methacryloyloxypropylmethyldiethoxysilane-tetramethoxysilane copolymer, and a 3-methacryloyloxypropylmethyldiethoxysilane-tetraethoxysilane copolymer; copolymers containing an acryloyloxypropyl group, such as a 3-acryloyloxypropyltrimethoxysilane-tetramethoxysilane copolymer, a 3-acryloyloxypropyltrimethoxysilane-tetraethoxysilane copolymer, a 3-acryloyloxypropyltriethoxysilane-tetramethoxysilane copolymer, a 3-acryloyloxypropyltriethoxysilane-tetraethoxysilane copolymer, a 3-acryloyloxypropylmethyldimethoxysilane-tetramethoxysilane copolymer, a 3-acryloyloxypropylmethyldimethoxysilane-tetraethoxysilane copolymer, a 3-acryloyloxypropylmethyldiethoxysilane-tetramethoxysilane copolymer, and a 3-acryloyloxypropylmethyldiethoxysilane-tetraethoxysilane copolymer; copolymers containing a vinyl group, such as a vinyltrimethoxysilane-tetramethoxysilane copolymer, a vinyltrimethoxysilane-tetraethoxysilane copolymer, a vinyltriethoxysilane-tetramethoxysilane copolymer, a vinyltriethoxysilane-tetraethoxysilane copolymer, a vinylmethyldimethoxysilane-tetramethoxysilane copolymer, a vinylmethyldimethoxysilane-tetraethoxysilane copolymer, a vinylmethyldiethoxysilane-tetramethoxysilane copolymer, and a vinylmethyldiethoxysilane-tetraethoxysilane copolymer; and copolymers containing an amino group, such as a 3-aminopropyltrimethoxysilane-tetramethoxysilane copolymer, a 3-aminopropyltrimethoxysilane-tetraethoxysilane copolymer, a 3-aminopropyltriethoxysilane-tetramethoxysilane copolymer, a 3-aminopropyltriethoxysilane-tetraethoxysilane copolymer, a 3-aminopropylmethyldimethoxysilane-tetramethoxysilane copolymer, a 3-aminopropylmethyldimethoxysilane-tetraethoxysilane copolymer, a 3-aminopropylmethyldiethoxysilane-tetramethoxysilane copolymer, and a 3-aminopropylmethyldiethoxysilane-tetraethoxysilane copolymer.

The silane coupling agent is a compound containing a Si element, which has, at a terminal, at least one functional group such as a vinyl group, an epoxy group, a styryl group, a methacryloyl group, an acryloyl group, an amino group, an isocyanurate group, a ureido group, a mercapto group, an isocyanate group, a carboxy group, or a hydroxy group selected from the group consisting of these groups, and at least one alkoxy silyl group or silanol group.

Among these, as the silane coupling agent, a silane coupling agent having an alkoxy silyl group and another different reactive group (for example, the above-described functional group) is preferable. Furthermore, from the viewpoint that the vertical alignment property of the liquid crystal compound is more excellent, as the silane coupling agent, a silane coupling agent having an alkoxy silyl group and a polar group is preferable. Examples of the polar group include an epoxy group, an amino group, an isocyanurate group, a mercapto group, a carboxy group, and a hydroxy group. The polar group may have a substituent or a protective group as appropriate in order to control the reactivity of the silane coupling agent.

Specific examples of the silane coupling agent include vinyltrimethoxysilane, vinyltriethoxysilane, vinyltris(2-methoxyethoxy)silane, N-(2-aminoethyl)-3-aminopropylmethyldimethoxysilane, N-(2-aminoethyl)-3-aminopropyltrimethoxysilane, 3-aminopropyltriethoxysilane, 3-triethoxysilyl-N-(1,3-dimethyl-butyridene)propylamine, 3-glycidoxypropyltrimethoxysilane, 3-glycidoxypropylmethyldimethoxysilane, 2-(3,4-epoxycyclohexyl)ethyltrimethoxysilane, 3-chloropropylmethyldimethoxysilane, 3-chloropropyltrimethoxysilane, 3-methacryloyloxypropyltrimethoxysilane, 3-mercaptopropyltrimethoxysilane, 3-glycidoxypropyltrimethoxysilane, 3-glycidoxypropyltriethoxysilane, 3-glycidoxypropyldimethoxymethylsilane, and 3-glycidoxypropylethoxydimethylsilane.

Examples of a commercially available silane coupling agent include silane coupling agents manufactured by Shin-Etsu Chemical Co., Ltd., such as KP321, KP323, KP324, KP326, KP340, KP341, X22-161A, KF6001, KBM-1003, KBE-1003, KBM-303, KBM-402, KBM-403, KBE-402, KBE-403, KBM-1403, KBM-502, KBM-503, KBE-502, KBE-503, KBM-5103, KBM-602, KBM-603, KBM-903, KBE-903, KBE-9103, KBM-573, KBM-575, KBM-9659, KBE-585, KBM-802, KBM-803, KBE-846, KBE-9007, and KBE-9103.

A content of the silane compound (preferably, the nonionic silane compound) in the light absorption anisotropic film is preferably 0.01% to 5% by mass, more preferably 0.05% to 4% by mass, and still more preferably 0.1% to 3% by mass with respect to the total mass of the light absorption anisotropic film.

The ionic compound may be contained only one kind or two or more kinds. In a case where two or more kinds of ionic compounds are contained, the content of the ionic compound means the total content of the ionic compounds.

### <Adhesion Improver>

Examples of the adhesion improver include reactive additives described in paragraphs 0123 to 0129 of JP2019-091088A, and boronic acid monomers and polymers thereof described in paragraphs 0015 to 0028 of WO2015/053359A.

### [Characteristics of Light Absorption Anisotropic Film]

It is preferable that the aligned liquid crystal compound is immobilized in the light absorption anisotropic film. Among these, in the light absorption anisotropic film, it is more preferable that the vertically aligned liquid crystal compound is fixed.

It is preferable that the dichroic substance in the light absorption anisotropic film is aligned in a specific direction. Among these, in the light absorption anisotropic film, it is more preferable that the dichroic substance is aligned in one in-plane direction. In particular, it is still more preferable that the dichroic substance is also aligned in the vertically aligned liquid crystal compound.

As will be described later, the light absorption anisotropic film is preferably a film formed of a composition for forming a light absorption anisotropic film containing a liquid crystal compound, a dichroic substance, and a specific phenol compound.

In the light absorption anisotropic film according to the embodiment of the present invention, an angle θ (hereinafter, also abbreviated as “transmittance central axis angle θ”) between a transmittance central axis of the light absorption anisotropic film and a normal direction of a surface of the light absorption anisotropic film is 0° to 45°. The transmittance central axis angle θ is more preferably 0° to 35°, and still more preferably 0° or more and less than 35°.

Here, the transmittance central axis is a direction in which the highest transmittance is exhibited in a case where the transmittance is measured by changing an inclination angle (polar angle) and an inclination direction (azimuthal angle) with respect to a normal direction of a surface of the light absorption anisotropic film.

Specifically, the Mueller matrix at a wavelength of 550 nm is measured using AxoScan OPMF-1 (manufactured by Opto Science, Inc.). More specifically, in a case of the measurement, the azimuthal angle at which the transmittance central axis is inclined is first searched for, and then, the Mueller matrix at a wavelength of 550 nm is actually measured while changing the polar angle, which is an angle with respect to the normal direction of the surface of the light absorption anisotropic film, in various ways (for example, while changing the polar angle by 10 from −70° to 70°) in a plane (a plane including the transmittance central axis and orthogonal to the surface of the light absorption anisotropic film) including the normal direction of the light absorption anisotropic film along the azimuthal angle, and the transmittance of the light absorption anisotropic film is derived. As a result, the direction at which the highest transmittance is exhibited is defined as the transmittance central axis. The transmittance central axis denotes a direction of an absorption axis (major axis direction of a molecule) of the dichroic substance contained in the light absorption anisotropic film.

In addition, a single plate transmittance of the light absorption anisotropic film is preferably 40% or more, and more preferably 42% or more. The upper limit thereof is not particularly limited, but may be 60% or less.

In addition, a polarization degree of the light absorption anisotropic film is preferably 90% or more, more preferably 95% or more, and still more preferably 99% or more. The upper limit thereof is not particularly limited, but may be less than 100%.

In the light absorption anisotropic film, the single plate transmittance and the degree of polarization of the linear polarizer are measured using an automatic polarizing film measuring device: VAP-7070 (manufactured by Jasco Corporation).

### [Composition for Forming Light Absorption Anisotropic Film]

The light absorption anisotropic film according to the embodiment of the present invention is preferably formed of a composition for forming a light absorption anisotropic film containing a liquid crystal compound, a dichroic substance, and a specific phenol compound.

The various components that can be contained in the composition for forming a light absorption anisotropic film have the same meaning as the various components that can be contained in the above-described light absorption anisotropic film, and suitable aspects thereof are also the same.

However, suitable numerical ranges of the contents of the various components in the composition for forming a light absorption anisotropic film are the same as suitable ranges in which the “content of various components (mass %) with respect to the total mass of the light absorption anisotropic film” is read as “content of various components (mass %) with respect to the total solid content of the composition for forming a light absorption anisotropic film”. Specifically, the description “the content of the specific phenol compound is preferably X % by mass or more with respect to the total mass of the light absorption anisotropic film” is read as “the content of the specific phenol compound is preferably X % by mass or more with respect to the total solid content of the composition for forming a light absorption anisotropic film”. The composition for forming a light absorption anisotropic film may contain other components such as a polymerization initiator and a solvent, in addition to the various components described above.

### <Polymerization Initiator>

It is preferable that the composition for forming a light absorption anisotropic film contains a polymerization initiator. As the polymerization initiator, a photopolymerization initiator is preferable.

As the photopolymerization initiator, various compounds can be used without any particular limitation. Examples of the photopolymerization initiator include α-carbonyl compounds (U.S. Pat. Nos. 2,367,661A and 2,367,670A), acyloin ether (U.S. Pat. No. 2,448,828A), α-hydrocarbon-substituted aromatic acyloin compounds (U.S. Pat. No. 2,722,512A), polynuclear quinone compounds (U.S. Pat. Nos. 3,046,127A and 2,951,758A), a combination of a triarylimidazole dimer and a p-aminophenyl ketone (U.S. Pat. No. 3,549,367A), acridine and phenazine compounds (JP1985-105667A (JP-S60-105667A) and U.S. Pat. No. 4,239,850A), oxadiazole compounds (U.S. Pat. No. 4,212,970A), o-acyloxime compounds ([0065] of JP2016-027384A), and acylphosphine oxide compounds (JP1988-040799B (JP-S63-040799B), JP1993-029234B (JP-H5-029234B), JP1998-095788A (JP-H10-095788A), and JP1998-029997A (JP-H10-029997A)).

A content of the polymerization initiator in the composition for forming a light absorption anisotropic film is preferably 0.01 to 30 parts by mass, and more preferably 0.1 to 15 parts by mass with respect to 100 parts by mass of the total of the dichroic substance and the liquid crystal compound in the composition for forming a light absorption anisotropic film.

The polymerization initiator may be contained alone or two or more thereof may be contained. In a case where two or more kinds of polymerization initiators are contained, the content of the polymerization initiator means the total content of the polymerization initiators.

### <Solvent>

From the viewpoints of the workability and the like, it is preferable that the composition for forming a light absorption anisotropic film contains a solvent.

Examples of the solvent include organic solvents such as ketones (such as acetone, 2-butanone, methyl isobutyl ketone, cyclopentanone, and cyclohexanone), ethers (such as dioxane, tetrahydrofuran, tetrahydropyran, dioxolane, tetrahydrofurfuryl alcohol, and cyclopentyl methyl ether), aliphatic hydrocarbons (such as hexane), alicyclic hydrocarbons (such as cyclohexane), aromatic hydrocarbons (such as benzene, toluene, xylene, and trimethylbenzene), halogenated carbons (such as dichloromethane, trichloromethane (chloroform), dichloroethane, dichlorobenzene, and chlorotoluene), esters (such as methyl acetate, ethyl acetate, butyl acetate, and diethyl carbonate), alcohols (such as ethanol, isopropanol, butanol, and cyclohexanol), cellosolves (such as methyl cellosolve, ethyl cellosolve, and 1,2-dimethoxyethane), cellosolve acetates, sulfoxides (such as dimethyl sulfoxide), amides (such as dimethylformamide, dimethylacetamide, N-methylpyrrolidone, N-ethylpyrrolidone, and 1,3-dimethyl-2-imidazolidinone), and heterocyclic compounds (such as pyridine), and water. These solvents may be used alone or in combination of two or more kinds thereof.

Among these solvents, from the viewpoint that the effect of the present invention is more excellent, it is preferable to use an organic solvent and it is more preferable to use halogenated carbons or ketones.

A content of the solvent in the composition for forming a light absorption anisotropic film is preferably 80% to 99% by mass, more preferably 83% to 97% by mass, and still more preferably 85% to 95% by mass with respect to the total mass of the composition for forming a light absorption anisotropic film.

### [Manufacturing Method of Light Absorption Anisotropic Film]

A method for manufacturing the light absorption anisotropic film according to the embodiment of the present invention is not particularly limited as long as the light absorption anisotropic film having the above-described characteristics can be manufactured.

Examples of the method for producing a light absorption anisotropic film according to the embodiment of the present invention include a method including a step of applying the composition for forming a light absorption anisotropic film onto a substrate to form a coating film (hereinafter, also referred to as a “coating film forming step”) and a step of aligning a liquid crystalline component or a dichroic substance contained in the coating film (hereinafter, also referred to as an “alignment step”) in this order.

In a case where the above-described dichroic substance has liquid crystallinity, the liquid crystalline component is a component which also includes the dichroic substance having liquid crystallinity in addition to the above-described liquid crystal compound.

### —Coating Film Forming Step—

The coating film forming step is a step of applying the composition for forming a light absorption anisotropic film onto a substrate to form a coating film.

The composition for forming a light absorption anisotropic film contains the dichroic substance and the liquid crystal compound described above. The dichroic substance and the liquid crystal compound contained in the composition for forming a light absorption anisotropic film may have a polymerizable group. In a case where the dichroic substance and the liquid crystal compound have a polymerizable group (preferably, a photopolymerizable group), these compounds can be fixed in the light absorption anisotropic film in a curing step described later.

The substrate used in the present step is not particularly limited, and a substrate having an optical film described later or the like can be used.

In addition, an alignment film may be provided on the substrate as necessary. By providing the alignment film, the liquid crystalline component can be aligned. Examples of the alignment film include a photo-alignment film.

As the alignment film, for example, alignment films disclosed in paragraphs 0125 to 0132 of WO022/138728A can also be suitably used.

In the present step, the composition for forming a light absorption anisotropic film can be easily applied by using a composition for forming a light absorption anisotropic film, which contains a solvent, or using a liquid such as a melt obtained by heating the composition for forming a light absorption anisotropic film.

Examples of the coating method for the composition for forming a light absorption anisotropic film include known methods such as a roll coating method, a gravure printing method, a spin coating method, a wire bar coating method, an extrusion coating method, a direct gravure coating method, a reverse gravure coating method, a die coating method, a spraying method, and an ink jet method.

### —Alignment Step—

The alignment step is a step of aligning the liquid crystalline component contained in the coating film. In this manner, the light absorption anisotropic film according to the embodiment of the present invention is obtained.

The alignment step may include a drying treatment. By the drying treatment, components such as a solvent can be removed from the coating film. The drying treatment may be performed by a method of allowing the coating film to stand at room temperature for a predetermined time (for example, natural drying) or a method of heating the coating film and/or blowing air to the coating film.

Here, the liquid crystal components contained in the composition for forming a light absorption anisotropic film may be aligned by the coating film forming step or the drying treatment described above. For example, in an aspect in which the composition for forming a light absorption anisotropic film is prepared as a coating liquid containing a solvent, a coating film having light absorption anisotropy is obtained by drying the coating film and removing the solvent from the coating film.

In a case where the drying treatment is performed at a temperature equal to or higher than a transition temperature of the liquid crystalline component contained in the coating film from a liquid crystal phase to an isotropic phase, a heat treatment described below may not be performed.

From the viewpoint of manufacturing suitability or the like, a transition temperature of the liquid crystalline component contained in the coating film from the liquid crystal phase to the isotropic phase is preferably 10° C. to 250° C. and more preferably 25° C. to 190° C. In a case where the transition temperature is 10° C. or higher, a cooling treatment or the like for lowering the temperature to a temperature range in which the liquid crystal phase is exhibited is not necessary, which is preferable. In addition, in a case where the transition temperature is 250° C. or lower, a high temperature is not required even in a case where the coating film is heated until the phase transition to the isotropic phase is made for the purpose of suppressing alignment defects and waste of thermal energy and deformation and deterioration of the substrate can be reduced, which is preferable.

It is preferable that the alignment step includes a heat treatment. In this manner, since the liquid crystalline component contained in the coating film can be aligned, the coating film after being subjected to the heat treatment can be suitably used as the light absorption anisotropic film.

From the viewpoint of manufacturing suitability or the like, the heat treatment is performed at a temperature of preferably 10° C. to 250° C. and more preferably 25° C. to 190° C. In addition, the heating time is preferably 1 to 300 seconds and more preferably 1 to 60 seconds.

The alignment step may include a cooling treatment performed after the heat treatment. The cooling treatment is a treatment of cooling the heated coating film to room temperature (20° C. to 25° C.). In this manner, the alignment of the liquid crystalline component contained in the coating film can be fixed. A cooling unit is not particularly limited, and the cooling treatment can be performed according to a known method.

### —Other Steps—

The method of forming the light absorption anisotropic film according to the present invention may include a step of curing the light absorption anisotropic film after the above-described alignment step (hereinafter, also referred to as “curing step”).

The curing step is performed by, for example, heating and/or light irradiation (exposure) in a case where the compound contained in the light absorption anisotropic film has a polymerizable group. Among these, from the viewpoint of productivity, it is preferable that the curing step is performed by irradiating the light absorption anisotropic film with light.

Various light sources such as infrared rays, visible light, and ultraviolet rays can be used as the light source for curing, but ultraviolet rays are preferable. In addition, ultraviolet rays may be applied while the light absorption anisotropic film is heated during the curing, or ultraviolet rays may be applied through a filter which transmits only a specific wavelength.

In a case where the exposure is performed while the light absorption anisotropic film is heated, the heating temperature during the exposure depends on the transition temperature of the liquid crystalline component contained in the liquid crystal film, but it is preferably 25° C. to 140° C.

In addition, the exposure may be performed under a nitrogen atmosphere. In a case where the curing of the liquid crystal film proceeds by radical polymerization, since inhibition of polymerization by oxygen is reduced, it is preferable that the exposure is performed in a nitrogen atmosphere.

A thickness of the light absorption anisotropic film is not particularly limited, but from the viewpoint that the effect of the present invention is more excellent, the thickness is preferably 0.3 to 10 m and more preferably 0.5 to 9 m.

### [Optical Film]

The optical film according to the embodiment of the present invention is not particularly limited as long as it has a substrate and a light absorption anisotropic film disposed on the substrate. In the optical film according to the embodiment of the present invention, an alignment film may be disposed on a surface of the substrate on the light absorption anisotropic film side. In addition, the optical film according to the embodiment of the present invention may further have a protective layer on a surface of the light absorption anisotropic film opposite to the substrate.

Hereinafter, each member constituting the optical film will be described.

### [Base Material]

As the substrate, a known transparent resin film, a transparent resin plate, a transparent resin sheet, or the like can be used. Examples of the transparent resin film include a cellulose acylate film (such as a cellulose triacetate film (refractive index of 1.48), a cellulose diacetate film, a cellulose acetate butyrate film, or a cellulose acetate propionate film), a polyethylene terephthalate film, a polyether sulfone film, a polyacrylic resin film, a polyurethane-based resin film, a polyester film, a polycarbonate film, a polysulfone film, a polyether film, a polymethylpentene film, a polyether ketone film, and a (meth)acrylonitrile film.

Among these, a cellulose acylate film which is highly transparent, has a small optical birefringence, is easily produced, and is typically used as a protective film of a polarizing plate is preferable, and a cellulose triacetate film is more preferable.

A thickness of the substrate is usually 20 m to 100 m.

In the present invention, it is particularly preferable that the base material is a cellulose ester-based film having a film thickness 20 to 70 m.

In addition, the substrate may have an alignment film disposed on a surface on the light absorption anisotropic film side. As the alignment film, the above-described alignment film can be used.

### [Light Absorption Anisotropic Film]

The light absorption anisotropic film included in the optical film corresponds to the above-described light absorption anisotropic layer according to the embodiment of the present invention.

### [Protective Layer]

The optical film according to the embodiment of the present invention preferably further has a protective layer.

A material of the protective layer is not particularly limited, but from the viewpoint that the effect of the present invention is more excellent, for example, polyvinyl alcohol or a derivative thereof (hereinafter, also referred to as “polyvinyl alcohol-based resin”) is preferable.

The polyvinyl alcohol-based resin is not particularly limited, and examples thereof include partially saponified polyvinyl alcohol; completely saponified polyvinyl alcohol; carboxyl group-modified polyvinyl alcohol; reaction group-modified polyvinyl alcohols such as (meth)acryloyloxy group-modified polyvinyl alcohol, acetoacetyl group-modified polyvinyl alcohol, methylol group-modified polyvinyl alcohol, and amino group-modified polyvinyl alcohol; and polymers thereof.

A lower limit value of the thickness of the protective layer is not particularly limited, but from the viewpoint that the effect of the present invention is more excellent, it is preferably 0.01 m or more, more preferably 0.1 m or more, and still more preferably 0.5 m or more. From the viewpoint of reducing the thickness of the entire optical film and excellent productivity, an upper limit value of the thickness of the protective layer is preferably 100 m or less, more preferably 50 m or less, still more preferably 30 m or less, and particularly preferably 10 m or less.

### [Application of Optical Film]

The optical film according to the embodiment of the present invention is suitably used as a view angle control film that is used for controlling a view angle by being bonded to a polarizer having an absorption axis in a plane. In the following, the optical film having the above-described configuration may be referred to as a view angle control film.

The polarizer is preferably bonded to a side of the light absorption anisotropic film opposite to the substrate.

The polarizer is not particularly limited as long as it is a member having an absorption axis in a plane and having a function of converting light into specific linearly polarized light, and a known polarizer in the related art can be used.

### [Image Display Apparatus]

The image display apparatus according to the embodiment of the present invention is not particularly limited as long as it has the above-described optical film according to the embodiment of the present invention, and typically has the above-described optical film according to the embodiment of the present invention and a display element. The optical film according to the embodiment of the present invention is preferably mounted in an image display apparatus as the above-described view angle control film.

A display element used in the display device according to the embodiment of the present invention is not particularly limited, and examples thereof include a liquid crystal cell, an organic electroluminescence (hereinafter, abbreviated as “EL”) display panel, and a plasma display panel, among which a liquid crystal cell is preferable. That is, as the display device according to the embodiment of the present invention, a liquid crystal display device using a liquid crystal cell as the display element is preferable.

Among the image display apparatuses, there is a thin image display apparatus that can be molded into a curved surface. Since the light absorption anisotropic film used in the present invention is thin and easily bendable, it can be suitably applied to an image display apparatus in which a display surface is a curved surface.

In addition, some image display apparatuses have a pixel density of more than 250 ppi and are capable of high-definition display. The light absorption anisotropic film used in the present invention can be suitably applied to such a high-definition image display apparatus without causing moire.

### [Liquid Crystal Display Device]

Preferred examples of the liquid crystal display device, which is an example of the display device according to the embodiment of the present invention, include an aspect in which the view angle control film and the liquid crystal cell are included.

Specific configurations include a configuration in which the view angle control film is disposed on the front side polarizing plate or the rear side polarizing plate. In these configurations, the viewing angle at which the vertical direction or the horizontal direction is light-shielded can be controlled.

In addition, the view angle control film may be disposed on both the front side polarizing plate and the rear side polarizing plate. With such a configuration, it is possible to control the viewing angle in which light shielding is performed in all azimuth directions and light is transmitted only in the front direction.

Further, a plurality of view angle control films may be laminated through a phase difference layer. By controlling the phase difference value and the optical axis direction, the transmission performance and the light shielding performance can be controlled. For example, by disposing the polarizer, the view angle control film, the λ/2 wavelength plate (the axis angle is an angle deviated by 450 from the alignment direction of the polarizer), and the view angle control film, view angle control in which the entire periphery is shielded and only light in the front direction is transmitted can be performed. As the retardation layer, a positive A-plate, a negative A-plate, a positive C-plate, a negative C-plate, a B-plate, an O-plate, or the like can be used. From the viewpoint of reducing the thickness of the viewing angle control system, it is preferable that the thickness of the retardation layer is small as long as the optical characteristics, the mechanical properties, and the manufacturing suitability are not impaired, and specifically, the thickness thereof is preferably in a range of 1 to 150 m, more preferably in a range of 1 to 70 m, and still more preferably in a range of 1 to 30 m. Hereinafter, the liquid crystal cell constituting the liquid crystal display device will be described in detail.

### <Liquid Crystal Cell>

It is preferable that the liquid crystal cell used for the liquid crystal display device is in a vertical alignment (VA) mode, an optically compensated bend (OCB) mode, an in-plane-switching (IPS) mode, or a twisted nematic (TN) mode, but the present invention is not limited thereto.

In the liquid crystal cell in a TN mode, rod-like liquid crystalline molecules are substantially horizontally aligned at the time of no voltage application and further twisted aligned at 600 to 120°. The liquid crystal cell in a TN mode is most frequently used as a color TFT liquid crystal display device and is described in a plurality of documents.

In the liquid crystal cell in a VA mode, rod-like liquid crystalline molecules are substantially vertically aligned at the time of no voltage application. Examples of the VA mode liquid crystal cells include (1) a VA mode liquid crystal cell in a narrow sense (described in JP1990-176625A (JP-H2-176625A)) in which rod-like liquid crystal molecules are substantially aligned vertically in a case where no voltage is applied thereto and are substantially aligned horizontally in a case where a voltage is applied thereto, (2) a multi-domain VA mode (MVA mode) liquid crystal cell for enlarging the viewing angle (SID97, described in Digest of Tech. Papers (Proceedings) 28 (1997) 845), (3) a liquid crystal cell in a mode (n-ASM mode) in which rod-like liquid crystal molecules are substantially aligned vertically in a case where no voltage is applied thereto and are aligned in twisted multi-domain alignment in a case where a voltage is applied thereto (described in Proceedings of Japanese Liquid Crystal Conference, 58 and 59 (1998)), and (4) a SURVIVAL mode liquid crystal cell (presented in LCD International 98). The liquid crystal cell may be any one of a patterned vertical alignment (PVA) type, an optical alignment type, or a polymer-sustained alignment (PSA) type. These modes are described in detail in JP2006-215326A and JP2008-538819A.

In the liquid crystal cell in an IPS mode, liquid crystal compounds are aligned substantially parallel to the substrate, and the liquid crystalline molecules respond planarly through application of an electric field parallel to the substrate surface. That is, the liquid crystal compounds are aligned in the plane in a state where no electric field is applied. In the IPS mode, black display is carried out in a state where no electric field is applied, and absorption axes of a pair of upper and lower polarizing plates are orthogonal to each other. A method of improving a viewing angle by reducing leakage of light during black display in an oblique direction by using an optical compensation sheet is disclosed in JP1998-054982A (JP-H10-054982A), JP1999-202323A (JP-H11-202323A), JP1997-292522A (JP-H9-292522A), JP1999-133408A (JP-H11-133408A), JP1999-305217A (JP-H11-305217A), JP1998-307291A (JP-H10-307291A), and the like.

### EXAMPLES

Hereinafter, the present invention will be described in more detail based on Examples. The materials, the amounts of materials used, the proportions, the treatment details, the treatment procedure, and the like shown in Examples below may be appropriately modified as long as the modifications do not depart from the spirit of the present invention. Therefore, the scope of the present invention should not be construed as being limited to Examples.

### Example 1

### [Production of Optical Film 1]

An optical film including a light absorption anisotropic film was produced by the following procedure.

### <Formation of Alignment Film>

A surface of a commercially available cellulose acylate film (manufactured by FUJIFILM Corporation, trade name: FUJITAC TG60UL) was saponified with an alkaline solution, and the following composition 1 for forming an alignment film was applied thereto using a wire bar. The support on which the coating film was formed was dried with hot air at 60° C. for 60 seconds, and further dried with hot air at 100° C. for 120 seconds to form an alignment film AL1, thereby obtaining a cellulose acylate film 1 with an alignment film. A film thickness of the alignment film AL1 was 1 μm.

Composition 1 for forming alignment film

| | |
|---|---|
| Modified polyvinyl alcohol PVA-1 shown below | 3.80 parts by mass |
| Omnirad 2959 (manufactured by IGM | 0.20 parts by mass |
| RESINS B.V.) | |
| Water | 70 parts by mass |
| Methanol | 30 parts by mass |

(Modified polyvinyl alcohol PVA-1)
The composition ratio of each repeating unit is based on mol %.

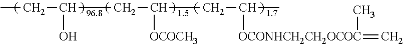

### <Formation of Light Absorption Anisotropic Film P1>

The obtained cellulose acylate film 1 with an alignment film was continuously coated with the following composition P1 for forming a light absorption anisotropic film using a wire bar, heated at 120° C. for 60 seconds, and cooled to room temperature (23° C.). Next, the coating layer was heated at 85° C. for 60 seconds, and then cooled to room temperature again.

Thereafter, the film was irradiated with an LED lamp (central wavelength: 365 nm) for 2 seconds under an irradiation condition of an illuminance of 200 mW/cm² from the film normal direction, thereby producing a light absorption anisotropic film P1 on the alignment film AL1, thereby obtaining an optical film 1. The film thickness of the light absorption anisotropic film P1 was 1.5 μm.

Composition P1 for forming light absorption anisotropic film

| | |
|---|---|
| Dichroic substance D-1 shown below | 0.78 parts by mass |
| Dichroic substance D-2 shown below | 0.21 parts by mass |
| Dichroic substance D-3 shown below | 1.39 parts by mass |
| Liquid crystal compound L-1 shown below | 7.39 parts by mass |
| Liquid crystal compound L-2 shown below | 2.46 parts by mass |
| Omnirad 369 (manufactured by IGM Resins B.V.) | 0.71 parts by mass |
| Phenol compound Ph-1 shown below | 0.036 parts by mass |
| o-xylene | 87.02 parts by mass |

(Dichroic substance D-1) 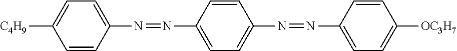
(Dichroic substance D-2) 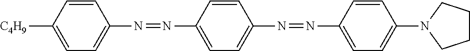
(Dichroic substance D-3) 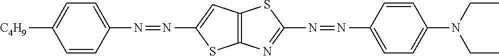
(Liquid crystal compound L-1) 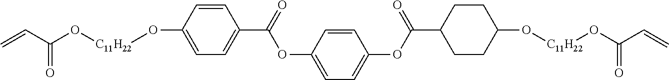
(Liquid crystal compound L-2) 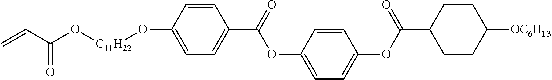
(Phenol compound Ph-1)

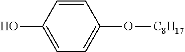

### Example 2

### [Production of Optical Film 2]

An optical film 2 was produced by the same method as in Example 1, except that, in the composition P1 for forming a light absorption anisotropic film of Example 1, the following phenol compound Ph-2 was used instead of the phenol compound Ph-1.

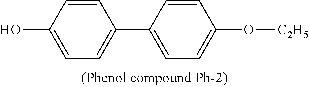 [SMILES: CCOc1ccc(-c2ccc(O)cc2)cc1]

### Example 3

### [Preparation of Optical Film 3]

An optical film 3 was produced by the same method as in Example 1, except that, in the composition P1 for forming a light absorption anisotropic film of Example 1, the following phenol compound Ph-3 was used instead of the phenol compound Ph-1.

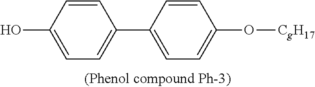

### Comparative Example 1

### [Production of Optical Film 4]

An optical film 4 was produced by the same method as in Example 1, except that the phenol compound Ph-1 was not used in the composition P1 for forming a light absorption anisotropic film of Example 1.

### Comparative Example 2

### [Production of Optical Film 5]

An optical film 5 was produced by the same method as in Example 1, except that, in the composition P1 for forming a light absorption anisotropic film of Example 1, the following antioxidant AO-1 was used instead of the phenol compound Ph-1.

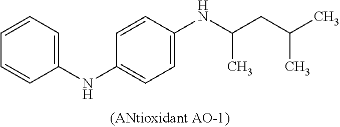 [SMILES: CC(C)CC(C)Nc1ccc(Nc2ccccc2)cc1]

### Example 4

### [Production of Optical Film 6]

An optical film 6 was produced by the same method as in Example 1, except that the following composition P6 for forming a light absorption anisotropic film was used instead of the composition P1 for forming a light absorption anisotropic film of Example 1.

Composition P6 for forming light absorption anisotropic film

| | |
|---|---|
| Dichroic substance D-4 shown below | 0.78 parts by mass |
| Dichroic substance D-5 shown below | 0.21 parts by mass |
| Dichroic substance D-6 shown below | 1.38 parts by mass |
| Liquid crystal compound L-1 shown above | 7.36 parts by mass |
| Liquid crystal compound L-2 shown above | 2.45 parts by mass |
| Omnirad 369 (manufactured by IGM Resins B.V.) | 0.71 parts by mass |
| Phenol compound Ph-1 shown above | 0.09 parts by mass |
| o-xylene | 87.02 parts by mass |

(Dichroic substance D-4) 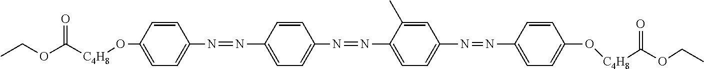
(Dichroic substance D-5) 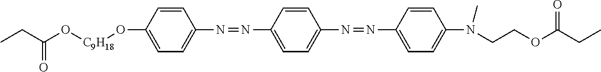
(Dichroic substance D-6)

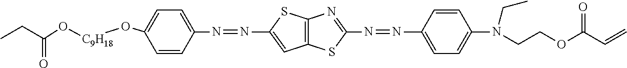

### Example 5

### [Production of Optical Film 7]

In the optical film 1 produced in Example 1, the composition 1 for forming an alignment film was further applied onto the surface of the light absorption anisotropic film P1 opposite to the cellulose acylate film side with a wire bar. The support on which the coating film was formed was dried with hot air at 60° C. for 60 seconds and further dried with hot air at 80° C. for 150 seconds to form a protective layer B1, thereby producing an optical film 7. A film thickness of the protective layer B1 was 1 m.

### Example 6

### [Production of Optical Film 8]

An optical film 8 was produced by the same method as in Example 1, except that the following composition P8 for forming a light absorption anisotropic film containing KBE-9103 (manufactured by Shin-Etsu Chemical Co., Ltd.), which is a silane coupling agent, was used instead of the composition P1 for forming a light absorption anisotropic film of Example 1.

Composition P8 for forming light absorption anisotropic film

| | | |
|---|---|---|
| Dichroic substance D-1 shown above | 0.77 | parts by mass |
| Dichroic substance D-2 shown above | 0.21 | parts by mass |
| Dichroic substance D-3 shown above | 1.37 | parts by mass |
| Liquid crystal compound L-1 shown above | 7.29 | parts by mass |
| Liquid crystal compound L-2 shown above | 2.43 | parts by mass |
| Omnirad 369 (manufactured by IGM Resins | 0.70 | parts by mass |
| B.V.) | | |
| Phenol compound Ph-1 shown above | 0.09 | parts by mass |
| KBE-9103 (manufactured by Shin-Etsu Chemical | 0.13 | parts by mass |
| Co., Ltd.) | | |
| o-xylene | 87.02 | parts by mass |

### Example 7

### [Preparation of Optical Film 9]

An optical film 9 was produced by the same method as in Example 1, except that the following composition P9 for forming a light absorption anisotropic film containing 1,1,1-tributyl-1-[(trimethoxysilyl)methyl]phosphonium bis(trifluoromethanesulfonyl)imide, which is an ionic compound, was used instead of the composition P1 for forming a light absorption anisotropic film of Example 1. The 1,1,1-tributyl-1-[(trimethoxysilyl)methyl]phosphonium bis(trifluoromethanesulfonyl)imide was synthesized with reference to JP6177430B.

Composition P9 for forming light absorption anisotropic film

| | | |
|---|---|---|
| Dichroic substance D-1 shown above | 0.77 | parts by mass |
| Dichroic substance D-2 shown above | 0.21 | parts by mass |
| Dichroic substance D-3 shown above | 1.37 | parts by mass |
| Liquid crystal compound L-1 shown above | 7.29 | parts by mass |
| Liquid crystal compound L-2 shown above | 2.43 | parts by mass |
| Omnirad 369 (manufactured by IGM Resins | 0.70 | parts by mass |
| B.V.) | | |
| Phenol compound Ph-1 shown above | 0.09 | parts by mass |
| 1,1,1-tributyl-1-[(trimethoxysilyl)methyl]phos- | 0.13 | parts by mass |
| phonium bis(trifluoromethanesulfonyl)imide | | |
| o-xylene | 87.02 | parts by mass |

### Comparative Example 3

### [Production of Optical Film 10]

An optical film 10 was produced by the same method as in Example 1, except that the following phenol compound Ph-4 was used instead of the phenol compound Ph-1 in the composition P1 for forming a light absorption anisotropic film of Example 1.

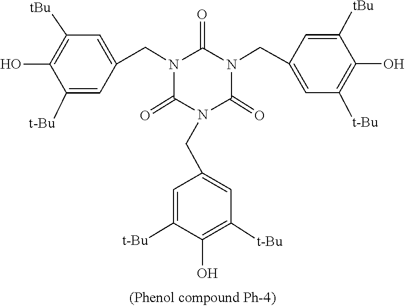 [SMILES: CC(C)(C)c1cc(Cn2c(=O)n(Cc3cc(C(C)(C)C)c(O)c(C(C)(C)C)c3)c(=O)n(Cc3cc(C(C)(C)C)c(O)c(C(C)(C)C)c3)c2=O)cc(C(C)(C)C)c1O]

### [Evaluation]

### [Transmittance Central Axis Evaluation]

The transmittance central axis of the obtained optical film was measured by the following method.

First, using AxoScan OPMF-1 (manufactured by Opto Science, Inc.), the azimuthal angle direction in which the transmittance central axis is inclined was detected, and the Mueller matrix at a wavelength of 550 nm was measured while changing the polar angle in various ways in the azimuthal angle direction to derive the transmittance, and the direction (polar angle) having the highest transmittance was defined as the direction of the transmittance central axis of the light absorption anisotropic film.

In each of the optical films of Examples and Comparative Examples, it was confirmed that the angle θ between the transmittance central axis of the light absorption anisotropic film and the normal direction of the surface of the light absorption anisotropic film was 0°.

### [Alignment Degree (Alignment Property) Evaluation]

The alignment degree of the obtained optical film at a wavelength of 550 nm was calculated by the following method.

In the measurement, the Mueller matrix at a wavelength of 550 nm at each polar angle was measured while the polar angle which was the angle with respect to the normal direction of the light absorption anisotropic film was changed from −70° to 700 at intervals of 1° using AxoScan OPMF-1 (manufactured by Opto Science, Inc.), and the minimum transmittance (Tmin) was derived.

Next, after removal of the influence of surface reflection, Tmin at a polar angle at which Tmin was highest was defined as Tm(0), and Tmin in a direction in which the polar angle was further increased by 40° from the polar angle at which Tmin was highest was defined as Tm(40).

The absorbance (A) was calculated from the obtained Tm(0) and Tm(40) by the following expression to calculate A(0) and A(40).

$$A = - log ( Tm )$$

Here, Tm represents a transmittance and A represents an absorbance.

The alignment degree S_{P} at a wavelength of 550 nm defined by the following expression was calculated from the calculated A(0) and A(40), and classified according to the following standard.

$${S}_{P} = ( 4.6 \times A ( 40 ) - A ( 0 ) ) / ( 4.6 \times A ( 40 ) + 2 \times A ( 0 ) )$$

A: alignment degree S_{P} of 0.90 or more
B: alignment degree S_{P} of 0.80 or more and less than 0.90
C: alignment degree S_{P} of 0.70 or more and less than 0.80
D: alignment degree S_{P} of less than 0.70

### [Evaluation of Light Resistance]

The obtained optical film was irradiated with xenon lamp light from the front direction for 150 hours using a Super Xe Weather Meter SX75 manufactured by Suga Test Instruments Co., Ltd.

Tm(40) before and after the irradiation was measured in the same manner as in the alignment degree evaluation, and the light resistance was evaluated according to the following standard. The change (%) of Tm(40) is calculated by the following expression.

$$Change ( \% ) of Tm ( 40 ) = 100 \times ( ( Tm ( 40 ) after irradiation ) - ( Tm ( 40 ) before irradiation ) ) / ( Tm ( 40 ) before irradiation )$$

A: change in change of Tm(40) of less than 2%
B: change in change of Tm(40) of 2% or more and less than 5%
C: change in change of Tm(40) of 5% or more and less than 10%
D: change in change of Tm(40) of 10% or more

Table 1 is shown below.

TABLE 1

| | | | | | Compar- | Compar- | | | | | Compar- |
|---|---|---|---|---|---|---|---|---|---|---|---|
| | | | | | ative | ative | | | | | ative |
| | | Exam- | Exam- | Exam- | Exam- | Exam- | Exam- | Exam- | Exam- | Exam- | Exam- |
| | | ple 1 | ple 2 | ple 3 | ple 1 | ple 2 | ple 4 | ple 5 | ple 6 | ple 7 | ple 3 |
| Optical film No. | | 1 | 2 | 3 | 4 | 5 | 6 | 7 | 8 | 9 | 10 |
| Light absorption | | P1 | P2 | P3 | P4 | P5 | P6 | P1 | P8 | P9 | P10 |
| anisotropic film No. | | | | | | | | | | | |
| Feature | Dichroic | D-1 | D-1 | D-1 | D-1 | D-1 | D-4 | D-1 | D-1 | D-1 | D-1 |
| component | substance | D-2 | D-2 | D-2 | D-2 | D-2 | D-5 | D-2 | D-2 | D-2 | D-2 |
| of light | | D-3 | D-3 | D-3 | D-3 | D-3 | D-6 | D-3 | D-3 | D-3 | D-3 |
| absorption | Phenol | Ph-1 | Ph-2 | Ph-3 | Absent | Absent | Ph-1 | Ph-1 | Ph-1 | Ph-1 | Ph-4 |
| anisotropic | compound | | | | | | | | | | |
| film | Non-phenol | Absent | Absent | Absent | Absent | AO-1 | Absent | Absent | Absent | Absent | Absent |
| | antioxidant | | | | | | | | | | |
| | Vertical | Absent | Absent | Absent | Absent | Absent | Absent | Absent | Silane | Ionic | Absent |
| | alignment | | | | | | | | coupling | compound | |
| | agent | | | | | | | | agent | | |
| Presence or absence of | | Absent | Absent | Absent | Absent | Absent | Absent | Present | Absent | Absent | Absent |
| protective layer | | | | | | | | | | | |
| Evaluation | Alignment | B | B | B | C | D | A | B | A | A | D |
| result | degree | | | | | | | | | | |
| | Light | B | B | B | D | B | A | A | B | B | B |
| | resistance | | | | | | | | | | |

From the results of Table 1, it is clear that the light absorption anisotropic film of Examples has excellent light resistance and excellent alignment property of the dichroic substance.

On the other hand, it is clear that, in a case where the light absorption anisotropic film does not contain any of the phenol compound and the non-phenol antioxidant, the light resistance is poor (Comparative Example 1).

In addition, it is clear that, in a case where the light absorption anisotropic film does not contain the specific phenol compound and contains a phenol compound or a non-phenol antioxidant that does not correspond to the specific phenol compound instead of the specific phenol compound, the light resistance is improved, but the alignment property is poor (Comparative Examples 2 and 3). From this result, it is considered that the specific phenol compound functions as a vertical alignment agent, while the phenol compound or the non-phenol antioxidant that does not correspond to the specific phenol compound is a component that hinders alignment.

In addition, from the comparison between Example 1 and Example 4, it was confirmed that, in a case where the light absorption anisotropic film has a dichroic substance having a predetermined structure, the light resistance and the alignment property of the dichroic substance are further excellent.

In addition, from the comparison between Example 1 and Example 5, it was confirmed that, in a case where the optical film further comprises a protective layer, the light resistance is further excellent.

In addition, from the comparison between Example 1 and Examples 6 and 7, it was confirmed that, in a case where the light absorption anisotropic film further contains a compound selected from the group consisting of a silane coupling agent, a hydrolyzate thereof, and a hydrolytic condensate thereof, and/or an ionic compound, the alignment property is further excellent.

What is claimed is:

1. Alight absorption anisotropic film comprising:
a liquid crystal compound;
a dichroic substance; and
a phenol compound,
wherein an angle θ between a transmittance central axis of the light absorption anisotropic film and a normal direction of a surface of the light absorption anisotropic film is 0° to 45°, and
the phenol compound includes a compound represented by Formula (1), 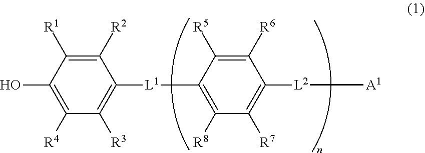
in Formula, R¹ to R⁸ each independently represent a hydrogen atom, a hydroxyl group, an alkyl group, or an alkoxy group, L¹ represents a single bond or a divalent linking group having no ring structure, L² represents a single bond or a divalent linking group, A¹ represents a group represented by Formula (2), a hydroxyl group, an alkyl group, or an alkoxy group, n represents an integer of 0 to 2, and in a case where n represents 2, a plurality of R⁵'s, a plurality of R⁶'s, a plurality of R⁷'s, a plurality of R⁸'s, and a plurality of L²'s may be the same as or different from each other, 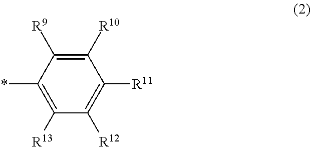
in Formula, R⁹ to R¹³ each independently represent a hydrogen atom, a hydroxyl group, an alkyl group, or an alkoxy group, and
* represents a bonding position.

2. The light absorption anisotropic film according to claim 1, further comprising:
one or more compounds selected from the group consisting of a silane coupling agent, a hydrolyzate of the silane coupling agent, and a hydrolytic condensate of the silane coupling agent.

3. The light absorption anisotropic film according to claim 1, further comprising:
an ionic compound.

4. An optical film comprising:
a substrate; and
the light absorption anisotropic film according to claim 1, disposed on the substrate.

5. The optical film according to claim 4, further comprising:
a protective layer on a surface of the light absorption anisotropic film opposite to a substrate side.

6. The optical film according to claim 5,
wherein the protective layer includes polyvinyl alcohol or a derivative of the polyvinyl alcohol.

7. An image display apparatus comprising:
the optical film according to claim 4.

8. The light absorption anisotropic film according to claim 2, further comprising:
an ionic compound.

9. An optical film comprising:
a substrate; and
the light absorption anisotropic film according to claim 2, disposed on the substrate.

10. The optical film according to claim 9, further comprising:
a protective layer on a surface of the light absorption anisotropic film opposite to a substrate side.

11. The optical film according to claim 10,
wherein the protective layer includes polyvinyl alcohol or a derivative of the polyvinyl alcohol.

12. An image display apparatus comprising:
the optical film according to claim 2.

13. An optical film comprising:
a substrate; and
the light absorption anisotropic film according to claim 3, disposed on the substrate.

14. The optical film according to claim 13, further comprising:
a protective layer on a surface of the light absorption anisotropic film opposite to a substrate side.

15. The optical film according to claim 14,
wherein the protective layer includes polyvinyl alcohol or a derivative of the polyvinyl alcohol.

16. An image display apparatus comprising:
the optical film according to claim 5.

17. An image display apparatus comprising:
the optical film according to claim 6.
